(19) United States
(12) Patent Application Publication
(10) Pub. No.: US 2025/0156603 A1
(43) Pub. Date: May 15, 2025

(54) METHOD AND APPARATUS FOR ADJUSTING A PREFORM FOR COMPRESSION MOLDING

(71) Applicant: 9T LABS AG, Zurich (CH)

(72) Inventors: Thomas NETTER, Winterthur (CH); Martin EICHENHOFER, Zurich (CH); Jonas BOSSHARD, Schaffhausen (CH); James LACKEY, Rafz (CH)

(73) Assignee: 9T LABS AG, Zurich (CH)

(21) Appl. No.: 18/840,225

(22) PCT Filed: Feb. 2, 2023
(86) PCT No.: PCT/IB2023/050930

§ 371 Date: Aug. 21, 2024

(30) Foreign Application Priority Data
Feb. 28, 2022 (WO) PCT/IB2022/051758
Nov. 16, 2022 (WO) PCT/IB2022/061036

(51) Int. Cl. G06F 30/23; B29C 70/34; G06F 30/17; G06F 113/22; G06F 113/26

(52) U.S. Cl. CPC G06F 30/23; B29C 70/345; G06F 30/17; G06F 2113/22; G06F 2113/26

(57) ABSTRACT

A computer-implemented method for forming a composite device of fiber-comprising tows, including: forming a first preform model having one or more anisotropic tow layup portions including fiber-comprising tows, receiving one or more mold geometrical components, receiving one or more molding force vector parameters comprising a compressive force, deforming the first preform model against the mold geometrical components using the molding force vector parameters to form an intermediate device model, forming a second preform model by adjusting the first preform model, and transmitting the second preform model to one or more systems for applying an elongate fiber tow onto an object surface, wherein adjusting the first preform model comprises cutting one or more of the tows into first tow and second tow segments to form a gap separating the first tow segment from the second tow segment along a corresponding tow path within the anisotropic tow layup portion.

### FIELD

This disclosure relates to apparatuses and methods for forming fiber-reinforced composite devices. The disclosure also relates to forming and adjusting the layup of fibers comprised in the devices, for example in the framework of a compression molding process step.

### BACKGROUND

Fiber-reinforced plastics (FRP), also called fiber-reinforced polymers, for example carbon fiber-reinforced plastics (CFRP) are widely used materials for lightweight structures, ranging from sports equipment, to automotive components, to aircraft structures. A method for manufacturing of FRP devices comprises depositing fiber tows, for example preimpregnated tows, onto a substrate. In some embodiments, manufacturing the device comprises forming a stack comprising a plurality of layers comprising FRP.

In some embodiments of the method, a manufacturing step comprises molding, for example compression molding. For example, molding or compression molding of an FRP device provides a method to form a device with greater strength characteristics than a non-molded device.

The present disclosure addresses problems and limitations associated with the related art.

### SUMMARY

A problem identified by the present inventors related to molding and to compression molding is that one or more of the tows and, for example, a resin that one or more of impregnates and neighbors the tow, moves or flows during the molding process. Another problem identified by the present inventors related to molding and to compression molding is that gases dissolved in one or more of the tows and the resin may coalesce into bubbles and transit within the device. A consequence is that the displacement of fibers, resin, and gases cause a variation in the structural characteristics of the manufactured device with respect that which was anticipated.

There is therefore a need for methods and tools to anticipate, alleviate, and control issues arising when forming a fiber-reinforced plastic (FRP) device, for example when forming an FRP device to be subjected to a manufacturing process comprising compression molding.

In one aspect, the present disclosure provides a computer-implemented method for forming a fiber-reinforced composite device comprising one or more fiber-comprising tow having a tow width, the method comprising the steps: forming a first preform model comprising one or more anisotropic tow layup portion comprising one or more fiber-comprising tow; receiving one or more mold geometrical component; receiving one or more molding force vector parameter; forming an intermediate device model by deforming the first preform model against the one or more mold geometrical component using the one or more molding force vector parameter; forming a second preform model; wherein the step of forming the second preform model comprises adjusting the first preform model by forming a tow layup adjustment vector comprising one or more vector (V_{1 . . . N}) extending from one or more tow of the first preform model to one or more tow of the second preform model as a function of one or more position transformation vector (U1 . . . N) extending from one or more position along the length of one or more tow of the first preform model to the corresponding position along the length of one or more corresponding tow of one or more intermediate device model.

In another aspect, the present disclosure provides a non-transitory computer-readable storage medium having collectively stored thereon executable instructions that, when executed by one or more processor of a computer system, cause the computer system to at least form a fiber-reinforced composite device according to the computer-implemented method for forming a fiber-reinforced composite device.

In another aspect, the present disclosure provides a system for applying an elongate fiber tow onto an object surface, the system comprising: one or more processor; one or more non-transitory computer-readable storage medium according to the non-transitory computer-readable storage medium comprising stored instructions to form a fiber-reinforced composite device; and one or more filament deposition foot.

### BRIEF DESCRIPTION OF DRAWINGS

FIGS. 1A, 1B, 1C are cross-sections of grooved wheels of a tow forming assembly for forming a tow or filament that comprises one or more folds along its longitudinal axis.

FIG. 1D is a cross-section of a tow having a rectangular cross-section formed by the tow forming assembly of FIGS. 1A-1E.

FIG. 1E is a side view of a tow forming assembly.

FIG. 2A is an isometric view of a first preform.

FIG. 2B is a top view of a layer comprised in the first preform.

FIG. 2C is a cross-sectional side view of the preform of FIG. 2A prior to compression between two components of a mold.

FIG. 2D is a cross-section of the preform of FIGS. 2A-2C in a deformed or intermediate device state after the step of compressing.

FIG. 2D is a cross-section of a second preform.

FIG. 2E is a cross-section of an adjusted preform after it has been deformed by compression molding.

FIG. 2F is a cross-section relating the tows of a first preform to the tows of a second preform.

FIG. 2G is a cross-section relating the tows of the first preform of FIG. 2A to the tows of the first preform after deforming as shown in FIG. 2D by compression molding.

FIG. 2H is an equation shown in relation to FIGS. 2F and 2G.

FIG. 3A is a cross-sectional side view of the first preform of FIG. 2A prior to compression between two mold components of a compression molding system.

FIG. 3B is an embodiment of a cross-section of the preform of FIG. 3A after compression molding and drilling an orifice ablating one or more tow.

FIG. 3C is an embodiment of a cross-section of the preform of FIG. 3A after compression molding and comprising an orifice wherein the orifice is draped by one or more tow.

FIG. 3D is an adjusted preform wherein a plurality of tows comprise one or more cuts and are spaced longitudinally from each other.

FIG. 3E is the preform of FIG. 3D after compression molding and comprising an orifice.

FIG. 3F presents an alternate embodiment of the preform of FIG. 3D.

FIG. 3G is a cross-section of the preform of FIG. 3F after, for example, being subjected to a method of compression molding.

FIG. 3H is a second embodiment of the compression molding system of FIG. 3A wherein, for example, geometrical features of mold geometrical components have been switched between bottom and top components.

FIG. 3I is a cross-sectional view of a molded device or modeled target device second embodiment, for example resulting from a preform of FIG. 3H having undergone, for example, a method of compression molding, for example within the compression molding system

FIG. 3J is a cross-sectional view of a further embodiment of a preform, for example an alternative to the preform of FIG. 3H.

FIG. 3K is a cross-sectional view of the preform at the end of the compression molding process, for example at time, with the preform formed into an alternative embodiment of the molded device or modeled target device that is presented in FIG. 3I.

FIG. 4 is a block diagram of a computer system for controlling a system for forming a fiber-reinforced composite device.

FIG. 5A is a block diagram of a method for forming a fiber-reinforced composite device.

FIG. 5B is a block diagram of a method for forming a cavity in a fiber-reinforced composite device.

FIG. 5C is a block diagram of a method for forming a compression molding.

FIG. 5D is a block diagram of components comprised in a simulation model.

FIG. 6A is a graph of a norm of a molding force vector parameter versus time.

FIG. 6B is a graph of a relative position of a first component with respect to a second component.

FIG. 7A is a schematic side view of a system for applying an elongate fiber tow onto an object surface.

FIG. 7B is a side view cross-section of a foot device.

FIG. 8A is a top view of a tow comprising a twist.

FIG. 8B is a top view of a tow comprising a plurality of twists.

FIG. 8C1 is a top view of a plurality of adjacent tows, some of which have a plurality of twists.

FIG. 8C2 is a side view of two layers each including a tow having a plurality of twists.

FIG. 8C3 is a top view of a plurality of adjacent tows including one or more twist wherein a first twist of a first tow is longitudinally offset from a second twist of a second tow.

FIG. 8C4 is a top view of a plurality of adjacent tows forming a valve in a closed configuration.

FIG. 8D is a top view of a plurality of adjacent tows, some of which have a twist, crossed by a tow having a twist.

FIG. 8E is a partial, top view of a plurality of adjacent tows, some of which have a twist, formed into a curved section of the respective tow.

FIG. 8F is a top view of a plurality of adjacent tows comprising a spacing region between two or more tows.

FIG. 8G is a top view of the plurality of adjacent tows of FIG. 8F after undergoing a process of compression molding.

FIG. 9 is a block diagram of a method for forming a layup.

### DETAILED DESCRIPTION

The present disclosure relates to many aspects regarding fiber-reinforced plastics (FRP) including, but not necessarily limited to, tow forming assemblies, resultant tows, preforms, computer systems for controlling a system for forming a fiber-reinforced composite device, methods for forming fiber-reinforced plastics, and methods for forming a layup.

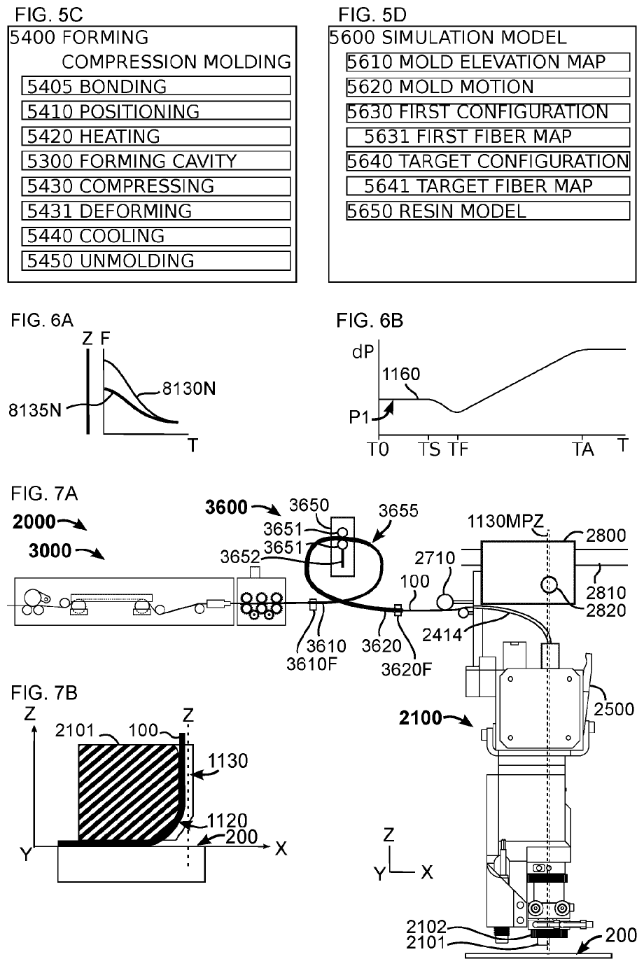

Mold. FIG. 5D illustrates one non-limiting example of a mold elevation map 5610 comprising a topological description of one or more internal surfaces of one or more mold components. For example, a mold elevation map 5610 comprises one or more (or two- or more) dimensional map of the internal surface of one or more mold components 8120, 8110, for example, a description or function relating the Z elevation coordinates of one or more points of the internal surface to one or more spatial coordinates, for example, to one or more Cartesian coordinates X and Y in a reference plane. For example, the mold elevation map 5610 comprises, at a given time instant, a surface of constant height (Z) with respect to a reference plane. For example, in some embodiments, a reference plane is a theoretical plane that is orthogonal to a predefined direction of motion of the mold component 8110, 8120 during a compression molding process. In some embodiments, for example, during a step of the compression molding process, a mold's elevation map deforms from a first mold elevation map at a first time instant to a second mold elevation map at a second time instant, that is, one or more of the spatial distribution and the spatial position of the elevation map is not constant in time.

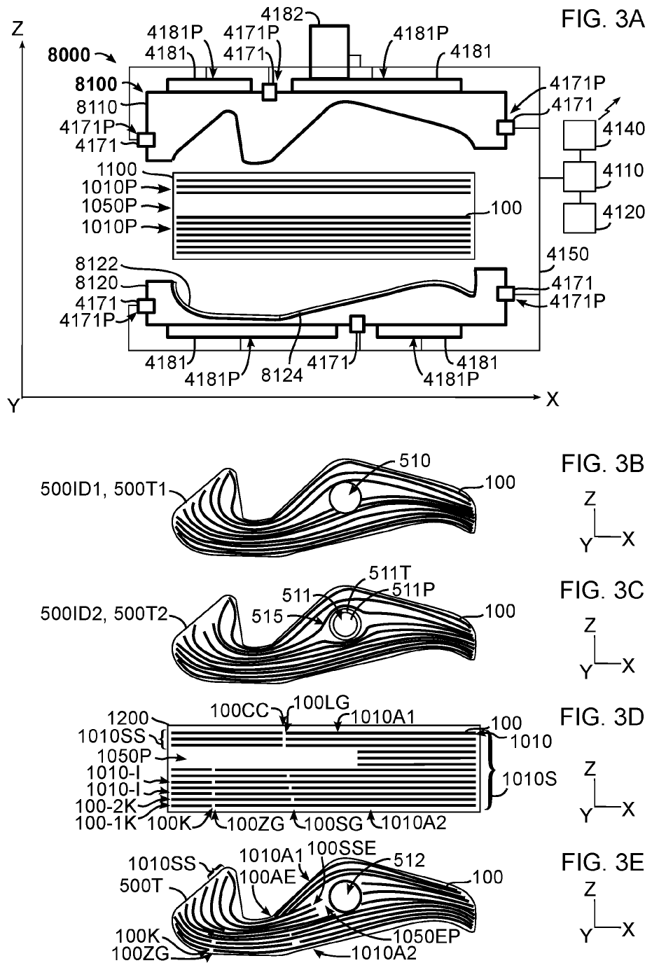

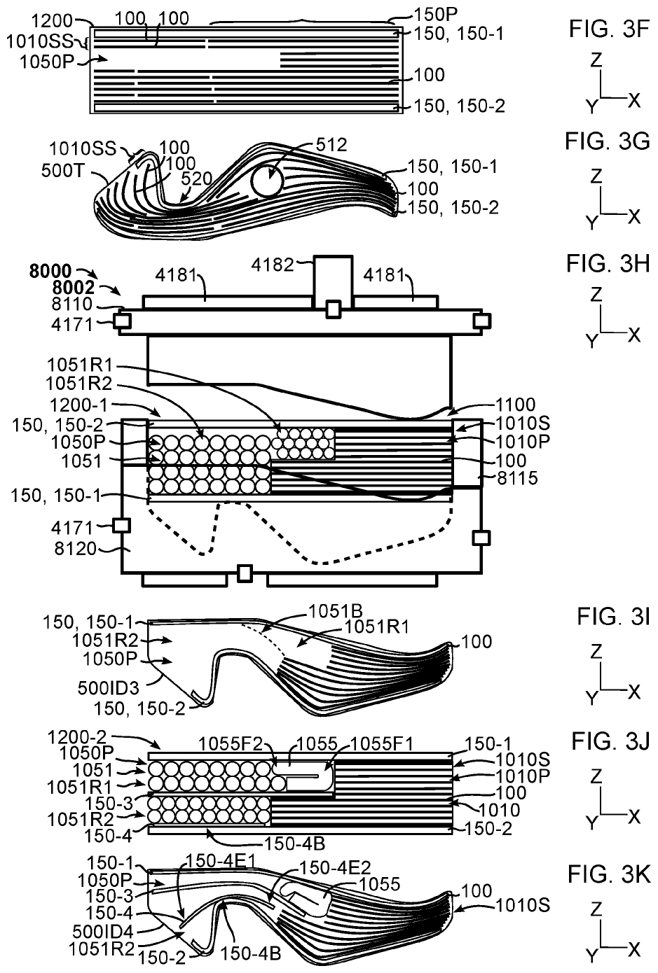

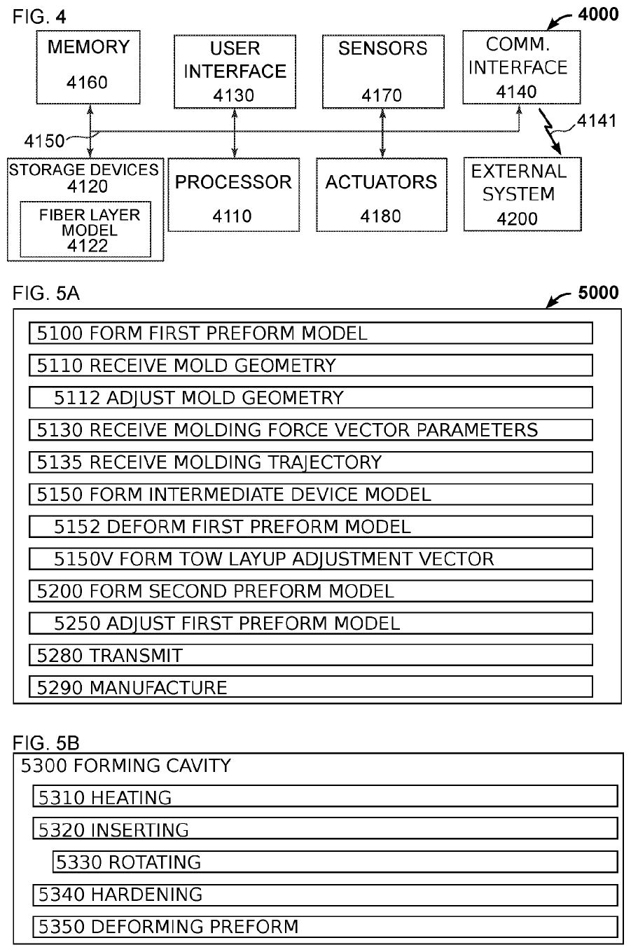

For example, an elevation map 5610 is represented as a digital elevation map, for example with respect to a baseline, for example the X axis shown in FIG. 3A, or a base surface, for example the X-Y plane. For example, the elevation is in the Z-direction, for example orthogonal to one or more of the X axis and the X-Y plane. For example, the digital elevation map 5610 is stored on a non-transitory computer-readable storage medium 4120 (see also, FIG. 4). In the rest of this description, it is assumed that descriptions have embodiments in one or more of real physical world and a simulated, computer-readable model or instructions, for example stored on a non-volatile computer-readable storage medium.

For example, referring in addition to FIGS. 3A and 3H, a mold 8000, 8100 comprises a smooth internal surface portion 8122. For example, a smooth internal surface has one or more of an average roughness and a root mean square average that is less than 0.025 μm, for example a surface roughness that is less than ISO grade N1. In some embodiments, the mold 8000, 8100 comprises an internal surface portion 8124 comprising one or more textures, for example in the form of one or more of grooves, indents, and embossings. For example, a surface region comprising texture features, for example having a roughness ISO grade that is, for example, less than N12, is approximated as a smooth surface, for example a smooth surface the elevation map of which is corrected, for example averaged, to account for the volume added or removed with respect to the surface region comprising the textures.

For example, the mold or molding system 8000, 8100 comprises one or more of one or more fixed mold components 8120 and one or more movable mold components 8110. For example, the movable mold component 8110 is one or more of translatable and rotatable, for example in one or more directions X, Y, Z. For example, the movable mold component 8110 can be translatable as a piston into one or more second mold component 8120. For example, the second mold 8120 component is configured as an enclosure or a partial enclosure. For example, the second mold 8120 component is configured to match the contour of the first mold component 8110, for example with one or more tolerances. For example, the tolerance is a function of the position of the first mold component 8110 with respect to the second mold component 8120.

Fiber layer elevation map. For example, as shown in FIG. 5D, a fiber map 5631, 5641 comprises, for example, a fiber layer elevation map which is an elevation map of a surface comprising one or more layer of fibers. For example, the fiber layer elevation map is described with respect to a reference surface X-Y, for example in the context of an additive manufacturing system, for example a filament deposition system, the reference plane, deposition plate, or substrate 200 (FIG. 7B). For example, a layer 1010 of fibers comprises an anisotropic layup of filaments 100, for example supplied onto the layup in the form of one or more tows or tapes comprising fibers. For example, the anisotropic layup comprises a constant thickness throughout the layer. In some embodiments, the surface comprising one or more layer of fibers does not fold back onto itself. In some other embodiments, the surface comprising one or more layers of fibers folds back onto itself. For example, the fiber layer elevation map is a description or function relating the Z elevation coordinates of one or more points of a fiber layer to one or more spatial coordinates, for example to one or more Cartesian coordinates X and Y in a reference plane. For example, the target fiber layer elevation map is a desired fiber layer elevation map, for example an elevation map obtained upon subjecting a fiber layer to one or more steps of compression molding. For example, the target fiber layer elevation map is a final elevation map obtainable upon deforming an initial fiber layer via one or more step of compression molding. For example, upon being subjected to one or more step of compression molding, an initial fiber layer transitions through one or more intermediate fiber layer elevation map prior to attaining the target fiber layer elevation map.

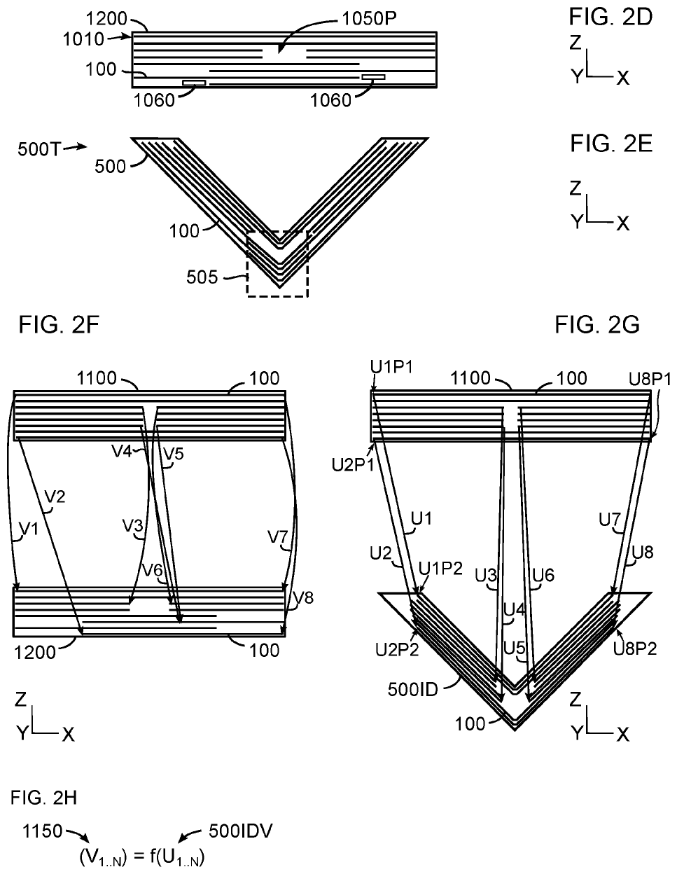

Fiber layer model. A fiber layer model 4122 comprises a description of one or more paths 100P1, 100P2, 100P3, 100P4 (FIG. 2B), for example paths comprising fibers. For example, the fiber layer model further comprises further comprises one or more resin paths 100P5. For example, a resin path is a line of resin or polymer, whether continuous or segmented, that is deposited by a fused deposition manufacturing system, for example comprising a nozzle. For example, a path comprises a line comprising one or more segments of paths comprising fibers and one or more segments that are resin paths, for example deposited as a continuous line or as a segmented line.

For example, the fiber layer model 4122 is stored in a computer memory 4160, 4120, for example as computer-readable instructions stored on a non-transitory computer-readable storage medium 4120. For example, a fiber layer model is formed as one or more paths of material, for example as a filament of material, for example as a filament of anisotropic material, for example comprising a plurality of elongate continuous fibers, for example as a tape 90, roving, or tow 100 comprising a plurality of fibers, onto a substrate. For example, a substrate is a reference plane 200 or a physical device, for example a preform, for example a preform comprising one or more layers.

For example, a filament or tow 100 comprises one or more of a tow, a roving, a tape, a commingled yarn, or a combination thereof. For example the combination is in one or more of: i) a parallel arrangement; and ii) a sequential arrangement along the longitudinal direction of the filament. For example, the filament comprises one or more thermoplastic resins. For example, the filament is preimpregnated with one or more thermoplastic resins. For a further example, the filament is impregnated with one or more thermoplastic resins within 10 minutes prior to or upon deposition of the filament onto a substrate. For example, the filament comprises one or more of: a plurality of continuous fibers, a plurality of discontinuous fibers, and a plurality of chopped fibers.

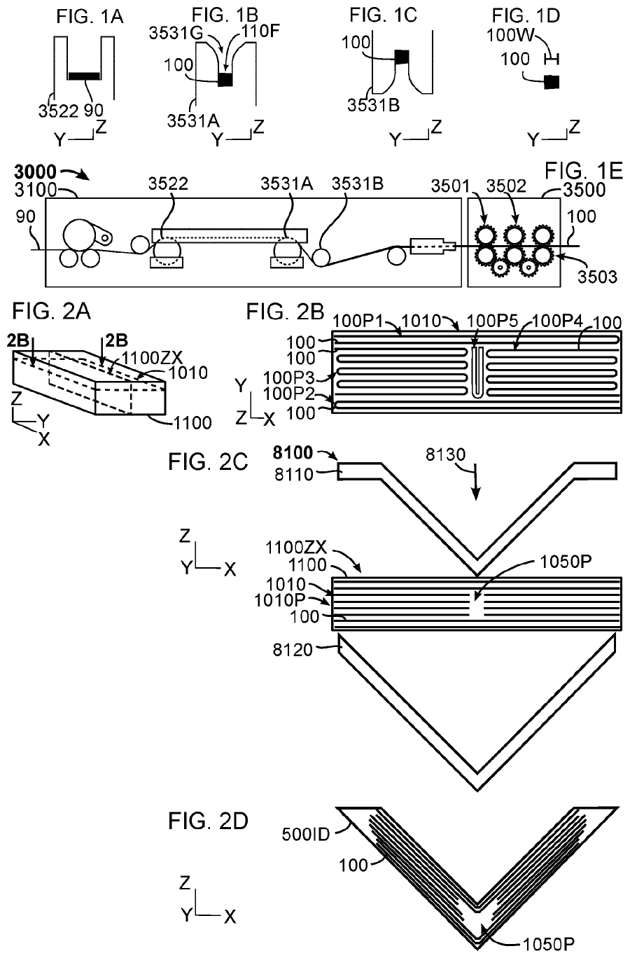

For example, a tow 100 comprises one or more tape 90 comprising fibers (FIG. 1A). For example, the tow 100 comprises the tape 90 comprising a fold 110F, for example the tow 100 is folded along its longitudinal axis (FIG. 1B). For example, as shown in FIGS. 1A, 1B, 1C and 1E, a method for folding the tape 100 comprises passing, for example pulling, the tape 90 into a groove 3531G of one or more grooved wheel 3522, 3531A, 3531B of a tow forming assembly 3000. For example, the tow forming assembly 3000 comprises one or more tow forming subunits 3100 comprising one or more of the grooved wheels 3522, 3531A, 3531B. For example the tow forming subunit heats the tape 90 to a temperature greater than that of the glass transition temperature of a thermoplastic that is comprised in the tape, for example a pre-impregnated tape. For example, the tow forming assembly comprises one or more tow traction subunits 3500, for example comprising one or more pinch roller assemblies 3501, 3502, 3503.

For example, a fiber layer model 4122 comprises a layer 1010 of constant thickness throughout the layer, for example within a tolerance in a range from 5 μm to 1 mm, for example from 20 μm to 500 μm, for another example from 5 μm to 200 μm, throughout the fiber layer.

For example, a path 100P1, 100P2, 100P3, 100P4, 100P5 of the one or more elongated tow 100 or line of resin is described using one or more of: a starting point; an ending point; and one or more waypoints. In some embodiments, the path, for example of the one or more elongated tow, is described using a path description format, for example in G-code or STEP-NC language. In some embodiments, the path comprises one or more descriptors, for example values, for the angle of twist, with respect to the longitudinal axis of the tow 100. In some embodiments, the fiber layer model comprises one or more of tow paths that, for example, comprise a given volume of resin per length of tow, and resin paths. For example, the resin path forms a binding between segments of one or more elongated tow. For example, one or more portions of a resin path is parallel to one or more portions of a fiber path. For example, one or more portions of a resin path is in the prolongation of one or more portions of a fiber path.

Layup. A layup refers to a volume of material, for example the preform 1100, comprising one or more materials, for example one or more layers of material deposited progressively in a filament or tape laying process. Referring to FIG. 2C, which illustrates a layup 1100 that comprises, for example, a layer 1010 comprising one or more deposited material. The deposited material comprises, for example, one or more of: one or more tow 100 comprising a plurality of fibers; one or more woven material; one or more foam; and one or more resin. A layup comprises, for example, one or more paths comprising one or more deposited elongated tows 100. For example, the one or more paths confer to the layup anisotropic characteristics within one or more regions of a surface or volume of the layup. For example, the mechanical properties in a first direction of the layup are different from the mechanical properties in a second direction of the layup, for example a second direction that is orthogonal to the first direction. For example, the layup comprises one or more regions wherein the one or more tow 100 is deposited unidirectionally.

Layup forming. Referring now in addition to FIG. 7A, which is a side view of a system 2000 for applying an elongate fiber tow, for example the tow 100, onto an object surface 200, for example onto one or more of: a preform 1200; a physical embodiment of a preform model 1200-2; and a computer-based rendering of a preform model 1200-2, for example comprising a computer-based rendering of the system for applying an elongate fiber tow 2000.

For example, the system 2000 for applying an elongate fiber tow comprises a tow buffer assembly 3600. For example, the tow buffer assembly 3600 comprises one or more flexible tubing assemblies comprising a first tube 3610 and a second tube 3620, wherein the outer diameter of the first tube is less than the inner diameter of the second tube and wherein the first tube is slidingly inserted into the second tube. For example, the buffer assembly 3600 wherein the outer diameter of the first tube is less than the inner diameter of the second tube enables a method wherein the first and the second tube slide, for example telescopically, with respect to each other at a telescoping point 3655 as the tension on the tow 100, that passes within the first tube 3610 and the second tube 3620, successively increases and decreases as the tow 100 is supplied by the tow forming assembly 3000 and demanded by a pinch wheel assembly 2500 comprised in a tow deposition head 2100. For example a distal end of the first tube 3610 is locked at a first position 3610F and a distal end of the second tube 3620 is locked at a second position 3620F. For example, the tow buffer assembly 3600 comprises a sensing unit 3650 for measuring a deflection of one or more of the first tube 3610 and the second tube 3620. The sensing comprises, for example, one or more rollers 3651 the position of which is measured along a slot or rail 3652. For example, the system 2000 comprises a tow longitudinal tension detector 2710. For example, the tension detector 2710 comprises for example one or more wheels, for example one or more sliders, that is configured to be in contact with the tow 100 at a first end and coupled to a force measurement sensor, for example a strain gauge at a second end. For example, the tow 100 is guided into the tow deposition head 2100 via a guiding tube 2414.

FIG. 7B is a side view cross-section of a foot device 2101. FIG. 9 is a block diagram of a method 5500 for forming a layup (such as the layup of FIG. 2C), for example a layup comprising one or more of a tow 100 and an isotropic material. In various examples, the method 5500 for forming a layup comprises translating 5510 the tow deposition head 2100, for example with respect to a layup support 200. For example, the tow deposition head 2100 is comprised in a tow deposition system 2000. For example, the tow deposition head 2100 comprises a foot device 2101, for example a presser foot device, the name being inspired by the presser foot of a sewing machine. For example, the foot device or presser foot device 2101 comprises one or more portion, that comprises a flared end 1120 that joins with a plane that is, for example, parallel to and above the surface onto which the tow is being deposited. For example, the system 2000 comprises a slide head 2800 comprising one or more axes 2810, 2820. For example, the slide head 2800 comprises a first axis 2810 that is orthogonal to a second axis 2820. For example, a method for forming the layup, for example comprised in or forming a preform 1200, 1200-2, for example using the tow deposition head 2100, comprises depositing one or more tows 100, for example a section of an elongate fiber tow, onto a supporting surface, for example the substrate 200. For example, the depositing comprises bonding 5530, for example by forming a bonding point 100B, 100B1, 100B2 at one or more waypoint along the path, for example by forming a continuous bonding along the tow's length, the one or more tows 100 to the supporting surface. For example, the depositing comprises bonding the tow at a first location 100B1 and simultaneously translating the deposition while feeding tow material at a speed corresponding to, for example equal to, the linear speed of the deposition head with respect to the surface onto which the tow is being deposited. For example, depositing is onto one or more of: a portion of a mold 8100, 8110, 8120; a supporting surface 200; and a layer formed from a previously deposited layup. For example, a supporting surface comprises one or more of: a planar surface; a developable curved surface comprising one or more curve; and an intrinsic curved surface.

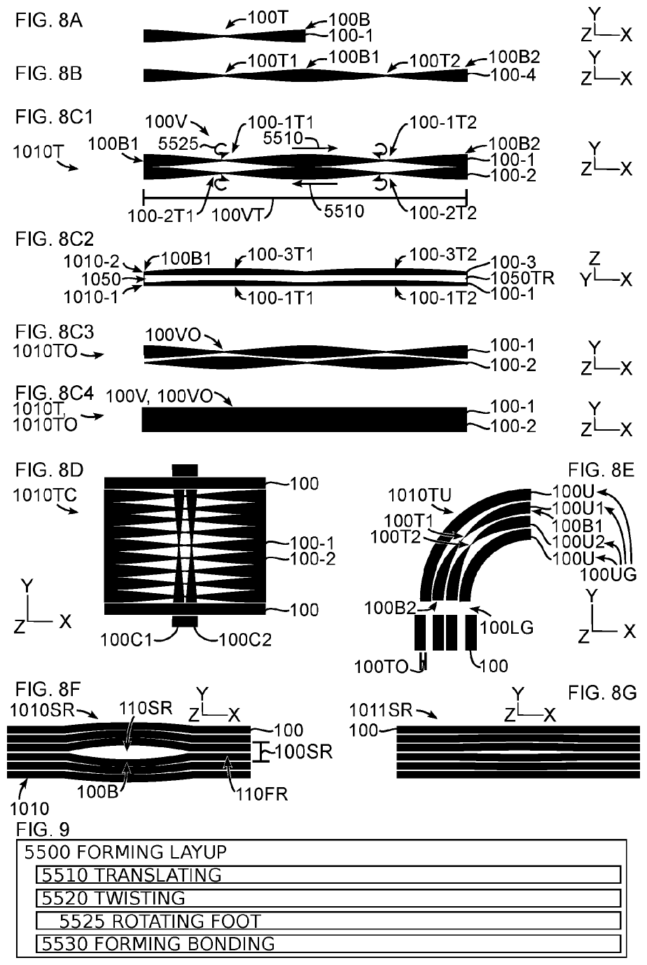

Forming twisted tow layup. FIG. 8A is a top view of a tow 100-1 comprising a twist 100T, which can be substituted for any tow of the disclosure. FIG. 8B is a top view of a tow 100-4 comprising a plurality of twists, for example a first twist 100T1 and a second twist 100T2, which can be substituted for any tow of the disclosure.

FIG. 8C1 is a top view of a plurality or assembly 1010T of adjacent tows 100-1, 100-2, for example of the assembly 1010T comprising a plurality of twisted tows 100-1, 100-2, for example a first tow 100-1 comprising a plurality of twists 100-1T1, 100-1T2 and a second tow 100-2 comprising a plurality of twists 100-2T1, 100-2T2. For example, a twist is around the longitudinal axis of the tow, for example a twist of at least 30°, for example a 180° twist, for example a twist of at least 180°, for example a plurality of 180° twists. For example, a first twist is 180° and a second, consecutive twist is 180° around the longitudinal axis of the tow 100. For another example, a first twist is 180° and a second, consecutive twist is −180° around the longitudinal axis of the tow 100. For example, FIG. 8C1 shows an example of translating 5510 and rotating 5525 directions of the rotating foot (which is also used for forming tows 100-1, 1002, 100U1, 100U2 comprising one or more twists shown in FIGS. 8A, 8B, 8C3, 8D, 8E) used for forming the twisted tows 100-1, 100-2. For example, a first tow 100-1 is twisted in a first direction and a second adjacent tow 100-2 is twisted in a second opposite direction as schematically represented with arrows. For example, the resulting adjacent first and second tow 100-1, 100-2, each twisted in an opposite direction with respect to each other, form a valve 100V that, for example, lets through or opposes a through-layer flow of resin in the region defined by a location of the twists 100T1, 100T2. A method for forming a valve 100V comprises forming a first tow 100-1 and a second tow 100-2 parallel to the first tow, for example wherein the twists in the first tow are adjacent to the twists in the second tow.

FIG. 8C2 is a side view of an assembly comprising a first layer 1010-1 and a second layer 1010-2, each comprising a tow 100-1, 100-3 comprising a plurality of twists 100-1T1, 100-1T2, 100-3T1, 100-3T2. For example, the first layer 1010-1 and the second layer 1010-2 are separated by a resin layer 1050, for example formed of one or more path or track of resin 1050TR formed by an additive manufacturing system, for example a 3D printing system. FIG. 8D is a top view of a plurality of adjacent tows 100, 101-1, 101-2, 100C1, 100C2 (not all of which are referenced for ease of illustration), for example of an assembly 1010TC comprising one or more first twisted tow 100-1, 100-2 crossed by one or more second twisted tow 100C1, 100C2.

Referring in particular to FIG. 9, for example, the method 5500 for forming a layup comprises rotating, for example twisting 5520, the tow (e.g., tow 100-1) around its longitudinal axis, for example using the foot device 2101 connected to a rotating support 2102, for example rotating around a rotating axis 1130MPZ (FIG. 7A), for example parallel to the Z axis. For example, one or more of the one or more axes 2810, 2820 is intersected by the Z-wise extension of the rotating axis 1130MPZ. For example, the method for forming a layup comprises bonding 5520 the tow with a twist 100T, 100T1, 100T2 around its longitudinal axis. For example, the method 5500 for forming a layup comprises translating 5510 the deposition head in a straight line and simultaneously bonding 5530 the tow, for example by forming 5520 a twist 100T along the tow's longitudinal axis, for example by forming a twist that varies in twist angle as a function of deposited distance. For example, a method 5520 for forming a twist 100T comprises simultaneously translating 5522 and rotating 5525 the deposition head, for example simultaneously translating and rotating the foot device 2101. For example, as shown in FIG. 8C1, each tow 100-1, 100-2 comprises the plurality of twists 100-1T1, 100-1T2, 100-3T1, 100-3T2 between a first bonding point 100B1 and a second bonding point 100B2.

For example, a method 5500 for forming a layup comprises forming one or more straight segment comprising one or more tow 100-1, 100-2 comprising one or more twist 100T1, 100T2 and comprises, for example, the steps of: 1) one or more of pressing and bonding the tow segment's starting point onto a surface; 2) simultaneously translating 5510 to form one or more straight path and rotating 5525 the foot device 2101, for example by rotating the foot device 2101 by an angle measured orthogonally to the surface and comprised in a range from 20° to 120°, for example after raising or separating the foot device by a distance comprised in a range from 0 mm to 10 mm, for example from 0.2 mm to 5 mm, away from the surface, for example to form a twisting in the tow; and 3) one or more of pressing and bonding the tow segment's ending point onto the surface. For example, the rotating 5525, for example the rotating of the foot 2101, for example against which the tow 100 or elongated fiber filament slides, for example slides along the axis of rotation Z of the foot 2101, comprises a plurality of rotations, for example comprising one or more rotation without translation, for example one or more 360° rotation. For example, the tow or filament slides within and along a groove 1130 formed in the foot 2101. For example, as shown in FIG. 7B, the tow 100 slides or, for example, descends along the axis of rotation Z, for example parallel to the axis of rotation Z, for example at a distance within 10 times, for example within 8 times, for example within 6 times, for example within 3 times the cross-sectional width of the tow.

For example, the tow or filament 100 has a width comprised in a range from 0.2 mm to 10 mm, for example from 0.4 mm to 5 mm, for example from 0.4 mm to 3 mm, for example from 0.4 mm to 2 mm, for example from 0.4 mm to 1 mm, for example from 0.45 mm to 0.6 mm. for example from 0.08 mm to 1 mm, for example from 0.1 mm to 0.5 mm, for example from 0.15 mm to 0.4 mm. For example, the tow or filament 100 is a tape is formed by cutting a sheet or a web comprising a plurality of fibers in a direction parallel to the fibers. For example, a filament, for example a tape, has a width in a range from 0.4 mm to 3 mm, for example from 0.6 mm to 2 mm, for example from 0.8 mm to 1.5 mm, for example from 0.9 mm to 1.2 mm.

For example, a tow or filament 100 comprises a plurality of discontinuous fibers. For example, the tow 100 comprises one or more sets of discontinuous fibers arranged as a plurality of parallel fibers. For example, the fibers in a filament comprising discontinuous fibers have a uniform length. For example, the discontinuous fibers have a length comprised in a range from 2 mm to 20 mm, for example from 2 mm to 10 mm, for example from 3 mm to 8 mm, for example from 3 mm to 6 mm. For example, the length-to-diameter ratio of a discontinuous fiber is in a range from 500 to 1500, for example from 600 to 1200. For example, a fiber having a length that is greater than that of a discontinuous fiber is a continuous fiber. For example, a fiber having a length that is less than that of a discontinuous fiber is a chopped fiber. For example, the discontinuous fibers are arranged parallel to the longitudinal direction of the filament. For example, at least 50%, for example more than 75%, for example more than 90%, for example more than 95% of the fibers are parallel to the longitudinal direction of the filament, for example within 15° of the longitudinal direction of the filament, for example within 10°, for example within 5°.

FIG. 8E is a top view of a plurality 1010TU of adjacent tows 100U, 100U1, 100U2, some of which 100U1, 100U2 comprise a twist, formed into a curved section or segment 100UG (generally referenced) of each tow. For example (FIG. 9), the method 5500 for forming a layup comprises forming one or more curved segment comprising a twisted tow 100U1, 100U2 and comprises, for example, one or more of the steps of: 1) pressing and bonding the tow segment's starting point 100B1 onto a surface; 2) simultaneously forming one or more curved path and rotating 5525 the foot 2101, for example by rotating the foot by an angle measured orthogonally to the surface and comprised in a range from 20° to 120°, for example to one or more of form, reduce, and cancel a twisting in the tow; and 3) pressing and bonding the tow curved segment's ending point 100B2 onto the surface. In another example of the method for forming a curved segment comprising a twisted tow, the deposition head, for example the foot 2101, is rotated over an angle greater than 120°, comprising a plurality of rotations, for example comprising one or more rotation without translation, for example one or more 360° rotation. For example, one or more of: the viscosity of molten thermoplastic comprised in the tow; tow friction, for example fiber friction against the foot 2101, for example against the foot's groove 1130; and the cross-sectional geometry of the tow, for example a rectangular geometry, causes a twisting entrainment of the tow as the foot is rotated, for example around the Z axis.

Cuts in path. In some embodiments, the method for forming a layup comprises forming one or more straight segment 100-1, 100-2, for example comprising forming a twisted tow in one or more straight segment, and continuing the path with the same elongated tow onto a curved segment, for example comprising forming a twisted tow. In other embodiments, the method for forming a layup comprises forming one or more cut or tow gap 100 LG in the elongated tow 100, 100U1, 100U2 to form one or more separate segment along the path, for example a straight path comprising one or more straight path segment and a curved path comprising one or more curved path segment 100U, 100U1, 100U2. For example, a path comprises one or more cut 100LG in the path wherein the distance from the ending point of a first segment to the starting point of a second segment is comprised in a range from 0.01 mm to 30 mm, for example from 0.03 mm to 5 mm. In a first example embodiment, the start of the second segment is configured to face the end of the first segment, for example in a collinear continuation of the end of the first segment. In a second example embodiment shown in FIG. 8E, the start of the second segment is configured with a lateral offset 100TO with respect to one or more of: the first segment's centerline; and an axis that is collinear with the end of the first segment.

Cuts in path: designs. For example, a layup comprises two or more parallel paths wherein a first path 100-1K, for example a tow 100 in the path, comprises a cut 100K at a first location along the path and a second path 100-2K, for example a tow 100 in the path, that is, for example, adjacent to the first path, comprises a cut 100K that is offset with respect to the first cut's location, for example as shown in the staircase gap arrangement 100SG in FIG. 3D. For example, the offset is comprised in a range from 0.01 mm to 30 mm, for example from 0.03 mm to 5 mm. For example, three or more parallel paths form a crenelated or alternating arrangement of cuts 100ZG, as shown in FIG. 3D, for example wherein a first cut in the first path extending along a first direction, for example the X-direction, is at the same level as a third cut in the third path extending along the first direction. For example, the crenelated arrangement of cuts within a plurality of parallel paths within a layup form a tenon and mortise arrangement of tows, for example as interleaving layers 1010-I shown in FIG. 3D. In another example, three or more parallel paths form a staircase arrangement 100SG of cuts within a plurality of parallel paths, for example adjacent paths, whether in one or more plane, for example one or more of plane X-Z and plane X-Y.

FIG. 8F is, for example, a top view of an assembly 1010SR comprising a plurality of adjacent tows 100 and comprising a spacing region 110SR between two or more tows 100. For example, the spacing region 110SR is comprised in a preform 1200, 1200-2. For example, the spacing region 110SR comprises a geometry comprising one or more of: an arch; an ogive; a lozenge; an arch buttress; and a spline, for example providing a progressive widening and narrowing of the spacing region along the general direction, for example the X-direction, upon which the one or more tow 100 is deposited. For example, the spacing region comprises a point of maximum width, for example along the Y-direction. For example, the point of maximum width comprises a bonding point 100B.

FIG. 5C is a block diagram of a method for forming a compression molding 5400. FIG. 8G is a top view of the assembly 1010SR comprising a plurality of adjacent tows of FIG. 8F after undergoing a method of compression molding 5400, whether in a physical compression molding system 8000 or a computer-implemented method 5000 for forming a molded device. The post-compression assembly 1011SR comprises the tows 100 of the assembly 1010SR that have, for example, been straightened during the compression molding process. For example, during an initial stage of the compression molding, whether physical 5400 or computer-implemented 5000, a portion of resin flows across the assembly 1010SR, for example along the Z-direction. As the preform 1200, 1200-2 deforms during the compression molding, one or more tow is straightened along at least a portion of the tow's longitudinal axis, for example the portion comprising the spacing region 110SR. For example, the straightening is induced by one or more of: deforming in the X-Z plane, for example induced by motion of one or more actuator, for example a compression actuator 4182; and flowing of resin along the tow's longitudinal axis, for example induced by one or more of the compression actuator 4182 and a temperature adjusting actuator 4181, for example comprising a heating device. For example, one or more of the straightening and the flowing causes: i) a reduction in resin flow across the layer 1010 comprising tows, for example across the X-Y plane, for example in the Z-direction; and ii) an increase in resin flow along the layer 1010 comprising tow, for example in the X-Y plane, for example in the X-direction.

Porosity/Permeability. For example, the method of forming of one or more of: twists 100T, 100T1, 100T2; cuts or gaps 100LG; tow ending offsets 100TO; crenelated arrangements 100ZG; staircase arrangements 100SG; and spacing region 100SR between two or more tows 100 along a direction orthogonal to an elongated tow's fiber axis; provides, for example, a method to form two or more regions in the layup, for example in two or more regions of a fiber layer, for example a fiber layer model, characterized by two or more different porosities, for example with respect to a flow of resin, for example a molten thermoplastic. For example, a fiber layer 1010 or its corresponding fiber layer model, comprises a first fiber layer region 110FR characterized by a first porosity value and a second fiber layer region 110SR characterized by a second porosity value that is greater than the first porosity value. For example, a method, for example a computer-based method, for forming a fiber-reinforced composite device comprises forming an estimate of the porosity value of a region of a fiber layer or of a fiber layup. For example, a method, for example a computer-based method, for forming a fiber-reinforced composite device comprises using an estimate of the porosity value of a region of a fiber layer for forming an estimate of one or more of: one or more in-plane permeability value, for example in the X-Y plane shown in FIG. 8F; and one or more through-thickness permeability value, for example across the X-Y plane.

Purpose. For example, the forming of one or more twists 100T, 100T1, 100T2 in a tow provides a method for guiding a flowing resin or matrix in an in-plane direction, for example towards a cut 100LG, for example serving as a preferred location for through-thickness or through-layer flow. For example, a method for forming a self-reconfigurable fiber layer 1010TC, 1010TU, 1010SR comprises including a tow comprising one or more of a twist 100T, 100T1, 100T2 and a spacing region 110SR into the fiber layer 1010. For example, a tow 100 comprising a twist one or more of alters its twist and curvature upon being subjected to one or more of resin flow and compression, for example upon being subjected to a compression molding process. For example, a fiber layer comprising one or more tow comprising one or more features of: a twist 100T, 100T1, 100T2; a cut 100LG; a tow ending offset 100TO; a crenelated arrangement 100ZG; a staircase arrangement 100SG; and a spacing 100SR between tows along a direction orthogonal to an elongated tow's fiber axis; provides a method to reconfigure one or more properties of: porosity; in-plane permeability; through-thickness permeability; structural strength and elasticity; tow layout; and resin distribution during a step of compression molding 5400. For example, the features enable control of motion of components and flow of resin during compression molding, for example forming an increased flow rate, compared to a layup that does not incorporate the features.

Resin stack. For example, the layup comprises one or more resin layer 1050, 1050P. For example, the one or more resin layer 1050, 1050P is stacked against one or more side of the fiber layer 1010. For example, the one or more resin layer comprises one or more portion 1050P that is comprised in one or more interval between two or more adjacent tows, for example running as one or more track of resin arranged between two adjacent parallel tow paths. For example, a first resin layer region is stacked against a first fiber layer region and a second resin layer region is stacked against a second fiber layer region. For example, the first resin layer region is characterized by a first porosity and the second resin layer region is characterized by a second porosity. For example, the second porosity value is greater than the first porosity value.

Valve. For example, as shown in FIG. 8C2, one or more track of resin 1050TR is arranged between two adjacent parallel and twisted tow paths 100-1, 100-3. For example, the two adjacent parallel and twisted tow paths provide a method for forming a valve 100V enabling a larger through-thickness (or through-fiber layer 1010) flow of resin in a first direction, for example the Z-direction, than in a second direction, for example a reverse direction, for example in the −Z-direction. For example, forming the two adjacent parallel and twisted tow paths is a method for letting through a flow of resin toward a region of a mold 8000, 8100, 8110, 8115, 8120 during, for example, a first stage of compression molding 5400 but restricting reverse flow during, for example, a second stage of compression molding. For example, a method for forming a twisting valve 100V with respect to the flow of resin comprises forming two adjacent parallel and twisted tow paths 100-1, 100-3 wherein each of the tow paths comprise an opposite twist direction wherein in the twisted region 100VT each tow is facing each other. For example, the amount of twist of each facing region 100VT is equal and opposite.

FIG. 8C3 presents a top view of an arrangement 1010TO comprising a plurality of adjacent tows 100-1, 100-3 comprising one or more twist wherein a first twist of a first tow 100-1 is longitudinally offset, for example in the X-direction, from a second twist of a second tow 100-3. For example, the arrangement 1010TO forms a valve 100VO comprising a first tow 100-1 comprising a first twist that is offset in the first tow's longitudinal direction with respect to a second twist of a second tow 100-3.

For example, a method for flowing resin across a valve 100V, 100VO comprises one or more of heating 5420 and compressing 5430 resin, for example resin comprised in a layup, for example in a preform 1200, 1200-2. For example, as shown in FIGS. 8C1 and 8C3, the valve is in an open configuration at a first stage of the compression molding process and, as shown in FIG. 8C4, in a closed configuration at, for example, a second stage of the compression molding process 5400, for example at the end of the compression molding process. For example, a method for enabling the motion or reconfiguration, for example in one or more of twist and translation, of a tow comprises supplying heat 5420 to the layup, for example to one or more fiber layers 1010, for example by supplying one or more of infrared radiation, plate heating, mold heating, and supplying a fluid at a temperature that is high enough to cause the resin or matrix to melt. For example, the fluid supplied comprises liquid resin, for example a thermoplastic resin.

Simulation. FIG. 5D is a block diagram of components comprised in a simulation model. For example, the compression molding process is formed as a simulation model, for example a computer-based simulation model 5600. For example, the compression molding process is adjusted by receiving instructions, for example computer-readable instructions 5000, generated by the computer-based simulation model. For example, the computer-readable instructions 5000 are stored on a non-volatile computer-readable storage device 4120. In some embodiments, the compression molding process is controlled, for example in real-time, by the computer-based simulation model.

FIG. 4 is a block diagram of a computer system 4000 for controlling a system for forming a fiber-reinforced composite device. For example, the system for forming a fiber-reinforced composite device comprises one or more of a: compression molding system 8000, and a system for applying an elongate fiber tow 2000. For example, control instructions are generated by the computer-based simulation model and transferred to a computer system or controller 4000 connected to a compression molding apparatus 8000. For example, the controller, for example a processor 4110, generates commands sent to actuators 4180, 4181, 4182 of the compression molding apparatus, for example commands setting one or more of: actuator position, for example in one or more of the X-, Y-, and Z-direction; actuator rate of motion; pressure supply; and heat supply 4181. For example, the computer system comprises a data bus 4150 connected to one or more sensors 4170, 4171 and one or more actuators 4180, 4181, 4182. For example, the data bus is connected to one or more of a computer-readable non-volatile storage medium 4120, the computer memory 4160, a user interface 4130, the processor 4110, the data communication device 4140, and an external system 4200, for example comprising one or more of: the system for applying an elongate fiber tow 2000, the compression molding apparatus 8000, for example each of which further comprises a computer system, for example operating as one or more of a client, a server, and a controller, for example to adjust one or more actuator using one or more of received commands and sensor data.

For example, the simulation model 5600 receives as input one or more of: a motion trajectory 5620 of the mold elevation map 5610; a first configuration 5630, for example comprising a first fiber map 5631, for example a first fiber elevation map of the one or more fiber layer model, for example a preform 1200, 1200-2; the target configuration 5640, for example comprising a target fiber map 5641, for example a target fiber layer elevation map; and the one or more resin layer model 5650.

For example, the motion trajectory 5620 comprises one or more of translation and rotation in one or more dimension of one or more point of the mold elevation map 5610 as a function of time. For example, the first configuration 5630 of the one or more fiber layer model comprises a computer-readable representation, for example as a three-dimensional model, of one or more of tow path 100 and resin content, for example comprising one or more of a layer of resin 1050, a track or path of resin 1050TR, a physical properties, for example one or more of thermal and viscoelastic properties of the resin.

For example, this disclosure presents a computer-implemented method 5000 for forming a fiber-reinforced composite device 500, for example by a compression molding method. For example, the fiber-reinforced composite device comprises one or more fiber-comprising tow 100. For example, the tow has a tow width 100W (FIG. 1D). For example, the width 100W of the tow or filament 100 is comprised in a range from 0.2 mm to 10 mm, for example from 0.4 mm to 5 mm, for example from 0.4 mm to 3 mm, for example from 0.4 mm to 2 mm, for example from 0.4 mm to 1 mm, for example from 0.45 mm to 0.6 mm.

FIG. 2A is an isometric view of a first preform 1100. For example, FIG. 2A shows a cross-section 1100ZX illustrated with visible layers 1010 of tows 100 in FIG. 2C. FIG. 5A is a block diagram of a method 5000 for forming a fiber-reinforced composite device. For example, the method 5000 comprises forming 5100 a first preform model 1100. For example, a preform model 1100 is a computer-based representation of a physical preform model. In this description, a model of an object is, for example, a digital computer-based representation of a physical object or process, for example comprising a discretized representation of an object or of steps for manufacturing an object. For example, the first preform model comprises one or more anisotropic tow layup portion 1010P. For example, the one or more anisotropic tow layup portion 1010P comprises one or more fiber-comprising tow 100.

FIG. 2C is a cross-sectional side view of the preform 1100 prior to compression between two components 8110, 8120 of a mold. FIG. 2D is a cross-section of a deformed preform or an intermediate device 500ID. For example, the method 5000 comprises receiving 5110 one or more mold geometrical component 8100, 8110, 8120. For example, a mold geometrical component comprises at least a portion, for example one or more portions, of an external contour, for example the geometric or finite element description of one or more external surfaces, of a device to be manufactured, for example an adjusted preform 500. For example, the method 5000 comprises receiving 5130 one or more molding force vector parameter 8130. For example, the method 5000 comprises receiving 5135 one or more molding trajectory 8135N. For example, as shown in FIG. 6A, the speed at which one or more actuators, for example the one or more compression actuators 4182, transition from a first state to a second state, is controlled as a function of time. For example, the transition comprises one or more linear segments (not shown). For example, the transition comprises follows a predefined curve, for example a spline, as shown in FIG. 6A. For example, the method 5000 comprises forming 5150 an intermediate device model 500ID. For example, forming 5150 an intermediate device model 500ID comprises deforming 5152 the first preform model 1100. For example, deforming 5152 the first preform model 1100 against the one or more mold geometrical component 8100. For example, deforming 5152 the first preform model 1100 uses the one or more molding force vector parameter 8130.

FIG. 2F is a cross-section relating, via an array of vectors (V_{1 . . . N}), the tows 100 of a first preform 1100 to the tows of a second preform 1200. FIG. 2G is a cross-section relating, via an array of vectors (U_{1 . . . N}), the tows 100 of a first preform 1100 to the tows of an intermediate device 500ID which is the first preform deformed by a method of compression molding 5000. For example, the method 5000 comprises forming 5200 a second preform model 1200. For example, forming 5200 the second preform model 1200 comprises adjusting 5250 the first preform model 1100. For example, adjusting 5250 the first preform model 1100 is done by forming 5150V a tow layup adjustment vector 1150. For example, the tow layup adjustment vector 1150 comprises one or more vector (V_{1 . . . N}) extending from one or more tow 100 of the first preform model 1100 to one or more tow of the second preform model 1200. FIG. 2H is an equation shown in relation to FIGS. 2F and 2G. For example, the tow layup adjustment vector 1150 is a function f of one or more position transformation vector (U_{1 . . . N}) 500IDV extending from one or more tow 100 of the first preform model 1100 to one or more tow 100 of one or more intermediate device model 500ID. For example, the one or more molding force vector parameter 8130 comprises one or more of a vector direction component and a vector norm value.

For example, the user interface 4130 comprises a computer display presenting a graphical user interface. For example, the graphical user interface presents one or more graphical representations, for example as shown in FIGS. 2F, 2G, and 3A to 3K, of one or more of the first preform model 1100, the intermediate device model 500ID, the second preform model 1200, the position transformation vector (U_{1 . . . N}), and the one or more vectors (V_{1 . . . N}) of the tow layup adjustment vector 1150. For example, the graphical presentations comprise an animation sequence. For example, the tows or portion of tows that undergo a rate of deformation or flow-related tow entrainment that is greater than a threshold or that are comprised in a region having a fiber density that becomes greater than or lower than a threshold during a step of deforming 5152 are presented with a highlighting feature. For example, the user interface presents one or more of a numerical and a symbolic indication to an operator to increase or decrease the fiber density in the region in one or more of the first preform model 1100, the intermediate device model 500ID, and the second preform model 1200. In a further example, the computer-readable non-transitory storage medium 4120 comprises instructions to increase or decrease, for example incrementally, the fiber density in the region, for example by addition or deletion of tows, so that it converges to a value that reduces the rate of deformation or flow-related tow entrainment.

FIG. 2E is a cross-section of an adjusted preform 500 after it has been deformed by a method of compression molding, for example a computer-implemented method 5000 for forming a molded device. For example, the method 5000 further comprises receiving at least a portion of a layup 505 of one or more target fiber-reinforced composite device 500T comprising one or more tow 100. For example, the portion of a layup 505 is received from a computer network, for example via the data communication device 4140, for example from an external system comprising one or more computer server 4200. For example, a portion of a layup is stored in one or more database comprising one or more portion of a layup 505, for example stored on one or more non-volatile computer-readable storage device 4120. For example, each of the one or more portion of a layup 505 is one or more of stored and exchanged with an associated identification label, for example stored in one or more digital ledger, for example a blockchain ledger, for example on one or more non-volatile computer-readable storage device 4120.

For example, a portion of a layup comprises one or more of: i) one or more specification for one or more tow 100, for example the one-, two-, or three-dimensional path of a tow 100, for example in the form of or comprised in one or more layer 1010, for example an anisotropic layer, for example according to a one-, two-, or three-dimensional specification; ii) one or more specification for one or more track, path, or volume of isotropic material, for example of resin 1050TR, for example of a volume comprising one or more pellet 1051, for example in the form of or comprised in one or more layer, for example an isotropic layup portion 1050P, for example according to a one-, two-, or three-dimensional specification; iii) one or more stack 1010S or substack 1010SS of layers; and iv) one or more cavity or orifice 512.

For example, the deforming the first preform model 1100 against the one or more mold geometrical component 8100 comprises a plurality of deforming steps. For example, the method 5000 further comprises receiving one or more tow trajectory specification joining one or more tow 100 of the first preform model to one or more tow 100 of the target fiber-reinforced composite device 500T. For example, forming 5150V the tow layup adjustment vector 1150 further comprises adjusting the tow layup vector as a function of the position of one or more tow 100 comprised in the target fiber-reinforced composite device 500T. For example, a position is measured with respect to a frame of reference, for example a three-dimensional frame of reference (X, Y, Z), for example anchored to one or more of: a manufacturing system 8000; a preform 1200; a preform component, for example a stack of layers 1010S or a layer 1010, 1050; and a tow 100 comprised in a preform.

For example, the method 5000 further comprises forming a finite element representation of the first preform model 1100. For example, the finite element representation comprises a mesh of quadrilateral elements. For example, a plurality of grid lines of the mesh are parallel to a plurality of tows comprised in the first preform model. For example, the finite element representation comprises a mesh of triangular elements. For example, a filament or tow 100 is represented or modeled as one or more of a discretized curve and a parametric model, for example one or more of a spline, and a Bezier curve. For example, the deforming comprises deforming the model of the tow using one or more mechanical finite element analysis methods, for example resulting in adjusting the position and orientation of one or more of the discrete components of the tow 100 or, for example if a parametric model is used, adjusting the nodes or control points of the model, for example spline or Bezier nodes or control points. For example, the model for a tow 100 includes parameters representing the mechanical properties of a tow, for example a preimpregnated tow, at one or more temperatures.

FIG. 6A is a graph of the norm of a molding force vector parameter 8130 versus time. For example, the one or more molding force vector parameter 8130 comprises a compressive force. For example, one or more of the molding force vector parameter 8130 has a norm 8130N that decreases over a portion of the time wherein the force is applied.

For example, one or more of the first preform model 1100 and the second preform model 1200 comprises one or more region 1010P comprising a layup of an anisotropic material. For example, one or more of the first preform model 1100 and the second preform model 1200 comprises one or more region 1050P comprising a layup comprising an isotropic material. For example, one or more of the first preform model 1100 and the second preform model 1200 comprises one or more region 1010P comprising a layup of an anisotropic material and one or more region 1050P comprising a layup comprising an isotropic material.

For example, the first preform model 1100 comprises a portion comprising a sandwich wherein at least a first layup 1050P of an isotropic material is sandwiched between at least a first layup comprising an anisotropic material and a second layup comprising an anisotropic material. For example, at least a portion of material comprised in the one or more region 1050P comprising a layup of an isotropic material flows from a first position to a second position. For example, at least a portion of material comprised in the one or more region 1010P comprising a layup of an anisotropic material has a first porosity and the one or more region 1050P comprising a layup of an isotropic material has a second porosity.

For example, one or more anisotropic tow layup portion 1010P comprises one or more layer comprising a plurality of parallel tows, each layer extending in a first direction X and a second direction Y. For example, one or more anisotropic tow layup portion 1010P comprises a plurality of layers stacked in a third direction Z and wherein one or more layer comprises a plurality of parallel tows.

For example, the adjusting the first preform model 1100 comprises, for one or more tow 100 of the anisotropic tow layup portion 1010P, one or more of: —measuring one or more distance separating the tow from an external contour of one or more of the first preform model and the second preform model 1200; and—measuring, in one or more direction with respect to a local direction along the longitudinal axis of the tow in the first preform model, one or more of: —one or more mold surface derivative; and—one or more mold surface radius of curvature.

For example, the adjusting the first preform model 1100 comprises estimating one or more resin viscosity value. For example, the estimating one or more resin viscosity value is estimated at one or more position within one or more the first preform model 1100, the intermediate device model 500ID, and the second preform model 1200. For example, the estimating one or more resin viscosity value is a function of one or more distance from one one or more mold geometrical component 8100, 8110, 8120. For example, the estimating comprises computing the temperature at one or more point in one of the X, Y, and Z dimensions using, for example, a model of temperature diffusion within the mold and adjusting the viscosity of the resin as a function fo temperature.

For example, the adjusting the first preform model 1100 comprises estimating one or more porosity value. For example, the estimating one or more porosity value is estimated at one or more position within one or more of the first preform model 1100, the intermediate device model 500ID, and the second preform model 1200. For example, the estimating the porosity comprises one or more of using a lookup table for porosity related to the filament layup process, accounting for separation between parallel layups of tows 100, and temperature at one or more point in one of the X, Y, and Z dimensions. For example, the adjusting the first preform model 1100 comprises translating one or more portion of one or more tow 100 from a first position to a second position. For example, the adjusting the first preform model 1100 comprises rotating one or more tow 100 from a first position to a second position within a surface parallel to that in which the tow is comprised.

For example, the adjusting the first preform model 1100 comprises longitudinally twisting one or more portion of one or more tow from a first twist orientation to a second twist orientation. For example, the adjusting the first preform model 1100 comprises forming one or more reservoir 1050P comprising an isotropic material. For example, the isotropic material comprises a thermoplastic resin. For example, the reservoir has a dimension in one or more direction (X, Y, Z) of at least one tow width. For example, one or more edge of the reservoir is at a position within a distance of at most 2 tow widths of one or more of the one or more anisotropic tow layup portion 1010P, the distance being measured orthogonally to the longitudinal axis of one or more tow of one or more of the one or more anisotropic tow layup portion. For example, one or more edge of the reservoir is at a position within a distance of at most 50 tow widths from an external contour of one or more of the first preform model 1100, the second preform model 1200, the intermediate device model 500ID, and the one or more mold geometrical component 8100, 8110, 8120, the distance being measured orthogonally to the longitudinal axis of one or more tow of one or more of the one or more anisotropic tow layup portion.

FIG. 2D is a cross-section of, for example, a second preform. For example, the adjusting the first preform model 1100 comprises forming one or more void region 1060. The adjusting the first preform model 1100 comprises estimating one or more of an in-plane porosity value and a through-plane porosity value with respect to the surface against which the one or more tow 100 is laid up in a layup. For example, the in-plane porosity value comprises one or more of a first in-plane porosity value in a first direction (X) and a second in-plane porosity value in a second direction (Y). For example, the in-plane porosity value comprises one or more of a first in-plane porosity value in a first direction that is parallel to a layup portion comprising the one or more tow and a second in-plane porosity value in a second direction that is orthogonal to a layup portion of the one or more tow.

For example, the adjusting the first preform model 1100 comprises cutting one or more tow 100 into a first tow and a second tow. For example, the adjusting the first preform model 1100 further comprises adjusting the length of one or more of the first tow and the second tow. For example, the adjusting the first preform model 1100 further comprises forming a gap along the longitudinal axis separating the first tow from the second tow. For example, the adjusting the first preform model 1100 further comprises filling the gap with an isotropic material.

For example, the deforming the first preform model 1100 against the one or more mold geometrical component 8100 comprises a plurality of deforming steps further comprising adjusting 5112 the geometric contour of the one or more mold geometrical component 8100, 8110, 8120 in one or more of the steps of the plurality of deforming steps. For example, the adjusting 5112 the geometric contour of the one or more mold geometrical component 8100, 8110, 8120 comprises compressing the first preform model 1100 between two or more geometrical components 8110, 8120.

FIG. 3A is a cross-sectional side view of a preform prior to compression between two mold components 8100, 8200 of a compression molding system 8000. For example, the compression molding system 8000 comprises one or more temperature sensor 4171 at one or more temperature sensor position 4171P. For example, the compression molding system 8000 comprises one or more temperature adjusting actuator 4181 at one or more temperature adjusting position 4181P. For example, the compression molding system 8000 comprises one or more compression actuator 4182.

For example, the deforming 5152 the first preform model 1100 further comprises adjusting the temperature of the one or more mold geometrical component 8100, 8110, 8120. For example, the adjusting the temperature comprises adjusting the temperature at one or more temperature adjusting position 4181P at the surface of the one or more mold geometrical component 8100, 8110, 8120. For example, each of the one or more temperature adjusting position 4181P has a spatial position and a spatial extent within the volume of the one or more mold geometrical component 8100, 8110, 8120. For example, the adjusting the temperature further comprises measuring the temperature of the one or more mold geometrical component 8100, 8110, 8120 at one or more temperature sensor position 4171P that is spatially distant from the one or more temperature adjusting position 4181P. For example, each of the temperature adjusting position 4181P comprises one or more of a heating element and a cooling element.

For example, the deforming 5152 the first preform model 1100 further comprises adding a volume of fluid into the volume enclosed within the one or more mold geometrical component 8100. For example, the fluid comprises a resin. For example, the fluid comprises a thermoplastic resin.

For example, the one or more anisotropic tow layup portion 1010P comprises a sequential arrangement of 3 or more parallel tows wherein a first spacing between a first tow and a second adjacent tow is greater than a second spacing between the second tow and a third tow adjacent to the second tow.

For example, the step of adjusting 5250 the first preform model 1100 comprises, in a sequential arrangement comprising 3 or more parallel tows, adjusting a first spacing between a first tow and a second tow adjacent to the first tow so that the first spacing is different from a second spacing between the second tow and a third tow adjacent to the second tow. For example, the adjusting 5250 the first preform model 1100 comprises, in a sequential arrangement comprising 4 or more parallel tows, forming a sequential arrangement of 3 or more spacings between successive tows wherein the third spacing is greater than the second spacing which is greater than the first spacing.

For example, the receiving 5110 one or more mold geometrical component 8100, 8110, 8120 comprises receiving a mold elevation map of at least a portion of the surface of the one or more mold geometrical component. For example, the receiving 5110 one or more mold geometrical component 8100, 8110, 8120 comprises estimating one or more derivative value at one or more location on the surface of the one or more mold geometrical component.

For example, the step of forming 5200 the second preform model 1200 further comprises receiving a target fiber layer elevation map of a surface comprising one or more layer of a layup comprising one or more fiber-comprising tow 100.

For example, the step of adjusting 5250 the first preform model 1100 comprises forming one or more resin layer against one or more surface of the first preform model 1100. For example, the one or more resin layer comprises one or more path, the width of one or more of the one or more path being equal to or greater than that of the tow width 100W.

For example, the step of forming a fiber-reinforced composite device 500 further comprises loading one or more of one or more tow layup adjustment vector 1150 and one or more position transformation vector 500IDV into a machine learning system. For example, the forming a fiber-reinforced composite device 500 further comprises loading a threshold vector set into the machine learning system, the threshold vector set comprising one or more tow position with respect to a threshold. For example, the step of forming a fiber-reinforced composite device 500 further comprises forming a plurality of candidate tow layup adjustment vectors comprising a position offset with respect to one or more tow of the one or more tow layup adjustment vector. For example, the step of forming a fiber-reinforced composite device 500 further comprises training the machine learning system to compare the one or more candidate tow layup adjustment vector to the one or more position transformation vector 500IDV.

FIG. 3B presents a side view of a first embodiment 500ID1, 500T1 of a cross-section of the preform 1100 of FIG. 3A after a compression molding process 5400. For example, forming the first embodiment 500ID1, 500T1 comprises forming 5300 a cavity or orifice 510, for example by drilling, for example by ablating a portion of one or more tow 100. For example, the drilling is done after completing the compression molding process 5400, for example after the forming 5200 of a second preform model, while at least a portion of the first embodiment 500ID1 is still comprised in the compression molding system 8000. In another example, the drilling is done after compression molding and after the first embodiment 500ID1 has been extracted from the compression molding system 8000. The drilling uses, for example, one or more drilling method, for example: drill bit drilling, laser drilling, and waterjet drilling.

For example, the first embodiment shown in FIG. 3B is a representation of an intermediate device model 500ID1 formed in a computer-implemented method 5000 for forming a molded device. For example, one or more position transformation vector (U_{1 . . . N}) is formed to extend from one or more tow 100 of the first preform model 1100 of FIG. 3A to one or more tow 100 of one or more intermediate device model 500ID1. For example, a position transformation vector extends from an end of a tow of the first preform model 1100 to the corresponding end of the corresponding tow 100 in the intermediate device model 500ID1. For example, one or more position transformation vector extends from one or more position U1P1, U2P1, U8P1 along the length of a tow 100 of the first preform model 1100 to the corresponding position U1P2, U2P2, U8P2 along the length of the corresponding tow 100 in the intermediate device model 500ID1. For example, the one or more position along the length of the tow 100 is selected according to one or more rule, for example one or more of: a regular periodic discretization; a discretization that is function of a curvature, for example a curvature in one or more intermediate device model 500ID1; a polynomial-based discretization; a moving nodes discretization; a refined and/or unrefined elements discretization; and a changing order of base functions discretization.

For another example, the representation of the first embodiment shown in FIG. 3B is a representation of a target device model 500T1. For example, the target device model 500T1 is the result of using one or more intermediate device model 500ID1 formed in a computer-implemented method 5000 for forming a molded device and depicted differently from that presented in FIG. 3B, for example with a different arrangement of tows 100, for example with an arrangement of tows with one or more of a different spatial distribution and tow path compared to that presented in FIG. 3B.

For a further example, FIG. 3B is a cross-sectional representation of a physical target device 500T1, for example derived from a photograph. For example, one or more coordinate of the position of one or more tow 100 is extracted from one or more photograph, for example using a computer-based digital image processing method, and the one or more coordinate is used to form the one or more position transformation vector (U_{1 . . . N}). For example, the computer-implemented method 5000 for forming a molded device comprises using one or more photograph to form the one or more position transformation vector (U_{1 . . . N}). For example, the computer-implemented method 5000 for forming a molded device comprises using one or more three-dimensional representation, for example formed from the acquisition of one or more photograph, to form the one or more position transformation vector (U_{1 . . . N}).

FIG. 3C presents a side view, for example a cross-sectional side view, of an embodiment 500ID2, 500T2 of a cross-section of the preform 1100 of FIG. 3A after a compression molding process. For example, the embodiment represents one or more of: an intermediate device model 500ID2 of a computer-implemented method 5000 for forming a molded device; and a target device model of the method 5000 or physical target 500T2 resulting from a compression molding process 5400. For example in this disclosure, a preform 1200 or a molded device 500T, 500T1, 500T2 is represented as one or more of a computer-implemented model, for example stored on a non-volatile computer-readable memory device, and a physical object, for example the physical characteristics of which, for example one or more of geometrical features, mechanical properties, and material characteristics, are also represented, for example stored, as a simulated model.

For example, the embodiment 500ID2, 500T2 comprises one or more of a cavity and orifice 511, thereafter called cavity, wherein the cavity is draped, for example partly surrounded by one or more tow. For example, draping corresponds to at least a portion of the path of one or more tow 100 being deflected from its original path, for example a straight path, by the displaced volume resulting from forming the cavity 511, for example by insertion of a pin 511P.

FIG. 5B presents a block diagram of a method 5300 for forming a cavity 511 in a fiber-reinforced composite device 500ID2, 500T2 for example in a preform 1100 used to form the fiber-reinforced composite device 500ID2, 500T2. For example, the tow-draped cavity 511 is formed by inserting 5320 a shaft into the preform 1100 prior to a compressing step 5430 of a method 5400 for forming a compression molding, for example for forming the fiber-reinforced composite device 500ID2, 500T2.

For example, a method 5300 for forming the tow-draped cavity 511 comprises heating 5310 the preform 1100 to a temperature equal to or greater than the glass transition temperature of the preform 1100, for example of the glass transition temperature of a region of isotropic material 1050P comprised in the preform 1100. For example, the method 5300 for forming the tow-draped cavity 511 comprises inserting one or more shaft or pin 511P into a region comprising, for example, the isotropic material 1050P at a temperature equal to or greater than the glass transition temperature of the preform 1100, for example of the glass transition temperature of the isotropic material 1050P. For example, the compressing step 5430 of the method 5400 for forming a compression molding comprises compressing 5430 the preform 1100 with one or more of the shaft or pin 511P inserted into the preform 1100. In an example embodiment of the shaft or pin 511P, the shaft or pin further comprises one or more sheath or tube 511T, for example forming a sliding fit around the shaft or pin 511P.

For example, the method 5300 for forming the tow-draped cavity 511 further comprises rotating 5330 one or more of the pin 511P and the tube 511T within one or more of the preform 1100 and the fiber-reinforced composite device 500ID2, 500T2. For example, the rotating 5330 is around the longitudinal axis of the pin 511P. For example, the rotating 5330 viscously entrains one or more of material of the isotropic layup portion 1050P and the anisotropic layup portion 1010P around at least a portion of the perimeter of the surface of the pin 511P comprised within one or more of the preform 1100 and the fiber-reinforced composite device 500ID2, 500T2. For example, the rotating further comprises motion in one or more direction orthogonal to the longitudinal axis of the pin 511P. For example, the rotating further comprises motion in a direction parallel to the longitudinal axis of the pin 511P.

For example, a method for forming at least a partial draping 515 by one or more fiber-comprising filaments of the anisotropic layup portion 1010P around at least a portion of the perimeter of the surface of the pin 511P comprises rotating 5330 one or more of the pin 511P and the tube 511T in one or more direction, for example in a clockwise and in an anti-clockwise direction, for example around the longitudinal axis of the pin. For example, the draping formed by one or more tow 100 corresponds to that of a streamline of fluid in a fluid flow, for example a laminar fluid flow. For example, the one or more of rotating and translating the pin 511P is a step in a method for adjusting the draping of one or more tow in a fiber-reinforced composite device, for example in a method to adjust one or more of the elastic characteristic of the fiber-reinforced composite device when it reaches a hardened configuration while it is in a soft configuration, for example at a temperature that is greater than the device's glass transition temperature, for example the temperature of the adhesive it comprises.

For example, the method for forming a compression molding 5400 comprises one or more step of hardening 5340, for example by one or more step of cooling 5440, of the preform 1100, for example in one or more region around the sheath or tube 511T. For example, a hardening step 5340 is done prior to a second heating step 5420 and a compressing step 5420. For example, the method 5300 for forming the tow-draped cavity 511 comprises deforming 5350 the preform 1200, 1200-2, for example against one or more of the components 8110, 8120 of the compression molding system 8000. For example, the method for forming a compression molding 5400 comprises a step of unmolding 5450 the deformed preform, for example by actuating one or more actuators, for example by one or more of moving one or more components and controlling one or more heating elements, for example the temperature adjusting actuators 4181. For example, one or more of the method or step for drilling, inserting, moving, draping, heating, hardening, and compression molding is modeled computationally, for example using one or more of a spatial and time discretization method, for example a finite element method, and comprised as one or more step in the computer-implemented method 5000.

FIG. 3D presents a cross-sectional view of a preform 1200 comprising two or more tows 100 separated by one or more tow gap 100LG along the tow's longitudinal axis. For example, the two or more tows 100 separated by a tow gap 100LG are formed by forming a cut that separates a tow into a first tow portion and a second tow portion. For example, a plurality of tows 100 are stacked in layers 1010. For example, as shown in the preform 1200 of FIG. 3D, a stack of layers 1010S extends in the Z-direction and each layer 1010 comprises one or more tow 100 extending in one or more of the X- and the Y-direction.

For example, a stack of layers 1010S comprises a plurality of layers wherein two or more tow gaps 100LG form a continuous column 100CC, for example in the Z-direction, of tow gaps. For example, a layer comprises a plurality of adjacent tows wherein two or more tow gaps 100LG form a continuous row, for example in the Y-direction, of tow gaps. For example, a stack of layers 1010S comprises a stack comprising a first layer adjacent to a second layer itself adjacent to a third layer comprises a zipper gap arrangement 100ZG wherein a tow gap 100LG in the first layer is aligned, along a direction orthogonal to the tow 100, for example in the Z-direction, with a tow gap 100LG in the third layer. For example, a stack of layers 1010S comprises a staircase gap arrangement 100SG wherein two or more gaps, for example three or more gaps, are arranged with a position offset in the tow's longitudinal direction from a first layer to a second layer. For example the offset is sequentially constant from a first layer to a second layer and on to a third layer. For example the staircase gap arrangement 100SG comprises one or more interleaving layer 1010-I between the first and the second layer, and one or more interleaving layer 1010-I between the second and the third layer.

For example the gap arrangement 100SG follows a predefined curve, for example a curve designed or computed by a computer-based tool usable in a computer-implemented method 5000 for forming a fiber-reinforced composite device, for example to predict the deformation of a preform subjected to one or more of pressure and temperature, for example within a compression molding system. For example, the gap arrangement 100SG in the preform is designed or computed so that following one or more step or method of compression molding, the resulting molded device or modeled target device 500T comprises one or more of a continuous column 100CC, a zipper gap arrangement 100ZG, and a constant-spaced staircase gap arrangement 100SG.

FIG. 3E presents a cross-sectional view of a molded device or modeled target device 500T. For example, the molded device comprises one or more zipper gap arrangement 100ZG. For example, the zipper gap arrangement 100ZG, although it has been deformed by the compression molding process, whether simulated or real, it remains a zipper gap arrangement 100ZG from the preform configuration 1200 to the target device 500T configuration. For example, a substack of layers 1010SS that is formed in the preform configuration 1200, for example by forming a continuous column 100CC that detaches the substack of layers 1010SS from, for example, the larger stack of layers 1010S, the substack of layers 1010SS transits from a first position in the preform 1200 to a second position in the target device 500T, for example relative to the stack of layers 1010S. For example, “larger” stack of layers 1010S means that the stack of layers comprises, relative to the substack of layers 1010SS, one or more of: a greater number of layers, tow segments of greater length, a greater cross-sectional surface, and a greater volume.

For example, in a method 5000 for forming the target device 500T the substack of layers 1010SS has transited from a first position in the preform 1200 to a second position to lodge or position itself between a first arm 1010A1 and a second arm 1010A2 of the stack of layers 1010S. For example in the method, the positioning of the substack of layers 1010SS between the first arm 1010A1 and the second arm 1010A2 of the stack of layers 1010S forms a tenon and mortise assembly comprising one or more substack of layers 1010SS comprised between one or more first arm 1010A1 and one or more second arm 1010A2 of one or more stack of layers 1010S.

For example, the positioning of the substack of layers 1010SS between the first arm 1010A1 and the second arm 1010A2 of the stack of layers 1010S forms an enclosed volume or portion of isotropic material 1050EP. For example the enclosed portion 1050EP is comprised within a plurality of anisotropic tow layup portions 1010P. For example, a plurality of tow extremities face the enclosed portion 1050EP. For example, a plurality of tow extremities of the substack of layers 1010SS face the enclosed portion 1050EP. For example, a plurality of tow extremities 100SSE of one or more substack of layers 1010SS faces the enclosed portion 1050EP and a plurality of tow extremities 100AE of the one or more arm 1010A1, 1010A2 is at the end of one or more curved tow 100, for example of one or more layer of tows 1010, that faces into one or more of the substack of layers 1010SS, for example as a result of one or more step of the method of compression molding 5400. For example, a curved tow 100 has a path that comprises a segment having a finite radius of curvature, for example a radius of curvature comprised in a range from 0.1 mm to 10 m.

For example, the portion of isotropic material 1050EP comprises one or more cavity or orifice 512. For example, the one or more cavity or orifice 512 is formed one or more of during and after one or more step of the method of compression molding 5400, for example by one or more of: inserting a tube 511T, inserting a pin 511P, and drilling. For example, the one or more cavity or orifice 512 comprises one or more of a tube 511T and a pin 511P.

FIG. 3F presents an alternate embodiment of the preform 1200 of FIG. 3D wherein the preform comprises one or more organosheet 150. An organosheet 150 is, for example, a consolidated sheet of material comprising one or more layer comprising fibers, for example fibers arranged in one or more tow or roving, for example one or more tow is arranged in a woven layer. For example, the one or more layer is impregnated with an adhesive material, for example a thermoplastic adhesive. For example, a thermoplastic adhesive comprises one or more of: a polyaryletherketone (PAEK), for example a polyether ether ketone (PEEK), for example a polyetherketoneketone (PEKK), a polyetherimide (PEI), an acrylonitrile butadiene styrene (ABS), a nylon, a polybutylene terephthalate (PBT), a polycarbonate (PC), a polycarbonate-ABS (PC-ABS), a polyether sulfone (PES), a polyethylene (PE), a polyethylene terephthalate (PET), a polyphenylene sulfide (PPS), a polyphenylsulfone (PPSU), a polyphosphoric acid (PPA), a polypropylene (PP), a polysulfone (PSU), a polyurethane (PU), and a polyvinyl chloride (PVC). For example, a thermoplastic further comprises a filler, for example a microsphere filler.

A fiber, for example comprised in a tow or roving, for example comprised in an organosheet 150, comprises one or more of: carbon fiber, a glass fiber, an aramid fiber, a basalt fiber, a metal fiber, and a natural fiber, for example an acetate fiber. For example, a natural fiber comprises fiber extracted from one or more of: a sisal, a flax, a ramie, a cotton, a banana, and a hemp. For example, a set of continuous fibers or a set of discontinuous fibers comprises fibers of one or more of the fiber materials. For example, a preform, for example an organosheet in a preform, comprises one or more electrically-conductive components, for example to confer so-called lightning or electrical arcing protection, for example one or more of: a conductive mesh, for example comprising a metal; a conductive filler, for example comprising nanotubes, for example carbon nanotubes; a foil, for example a metallic foil; and a conductive coating, for example comprising one or more of a metal, a metal oxide, and carbon nanotubes. For example, an organosheet has a thickness in a range from 0.1 mm to 20 mm, for example from 0.5 mm to 10 mm, for example from 0.7 mm to 8 mm. For example, the organosheet comprises one or more layer entirely comprising unidirectionally-arranged fibers. For example, the organosheet comprises one or more layer comprising tows arranged, for example woven, at a plurality of angles, for example 90°, for example 45°, for example in one or more weave, for example a plain weave, a twill weave, and a harness satin weave.

For example, the one or more organosheet 150 is positioned along at least a portion of one or more surface of the preform 1200. For example, two or more organosheets are configured so that at least a portion of a first organosheet 150-1 faces at least a portion of a second organosheet 150-2. For example, the first organosheet 150-1 and the second organosheet 150-2 form a sandwich along respectively a first and a second opposite surfaces of the preform 1200. For example, the material comprised between the first organosheet 150-1 and the second organosheet 150-2 comprises one or more of: an anisotropic layup portion 1010P, for example comprising one or more layer comprising one or more tow 150 comprising a plurality of fibers, for example a plurality of elongate unidirectional fibers, for example formed by a method of continuous elongate fiber deposition; and a portion comprising one or more isotropic material, for example an isotropic layup portion 1050P, for example comprising an adhesive, for example a thermoplastic adhesive. For example, the preform 1200 presented in FIG. 3F comprises one or more substack of layers 1010SS, here shown comprising a first and a second layer each comprising one or more tow 100, between the sandwich comprising two organosheets 150-1, 150-2. For example, as shown in FIG. 3J, the preform 1200, 1200-2 comprises a plurality of sandwiches, for example comprising a stack of two or more organosheets 150-1, 150-2, 150-3, 150-4, for example one or more of surrounding and embedded into the preform 1200, 1200-2.

FIG. 3G is an embodiment 500T of a cross-section of the preform of FIG. 3F after, for example, being subjected to a method of compression molding 5400. For example, compression-molded device 500T comprises an orifice 512. For example, the orifice 512 is drilled into one one or more of an isotropic material and one or more fibers, for example one or more tow 100. For example, a method for guiding the motion of a substack of layers 1010SS during a compression molding process 5400 comprises forming a preform 1200 wherein one or more substack of layers 1010SS is in contact with one or more organosheet 150-1, 150-2, 150-3, 150-4. For example, the organosheet comprises a portion 150P that extends in the direction of travel, for example extends towards the final position, of the substack of layers 1010SS at the end of the compression molding process 5400. For example, the organosheet is larger than the substack of layers 1010SS in the direction of displacement of the substack of layers, for example in the longitudinal direction of the one or more elongate tow 100 of the substack of layers.

For example, the method of compression molding 5400 comprises forming a concave surface into a preform 1200, for example by deforming 5431 an organosheet 150, for example an organosheet 150-1 positioned at the surface of the preform 1200, to form a concave surface portion 520. For example, the concave surface portion 520 guides the substack of layers 1010SS into a tenon position to form a tenon-and-mortise assembly (see FIG. 3D) between, for example, a first arm 1010A1 of a first stack of layers 1010SS and a second arm of the first stack of layers 1010SS or of a second stack of layers (not shown). For example, the layers in the second stack of layers are in a plane that is parallel to or at an angle with the layers in the first stack of layers (shown in FIG. 3F to extend in plane X-Y).

FIG. 3H presents a second embodiment 8002 of the compression molding system 8000 of FIG. 3A wherein, for example, the geometrical features of the mold geometrical components 8110, 8120 have been switched between bottom and top components. For example, the compression molding system 8000 further comprises an intermediate mold component 8115, the position of which is adjustable, for example along the direction along which the one or more mold geometrical component 8110, 8120 translates, for example in the Z-direction. For example, the first mold geometrical component 8110 translates, as a piston, with respect to the intermediate mold component 8115 and to the second mold geometrical component 8120.

For example, FIG. 3H presents the second embodiment 8002 of the compression molding system with a preform 1200-1 positioned, for example, onto the second or bottom mold component 8120 and, for example, at least partly enclosed, for example along one or more of its contours extending upwards, for example towards the Z-direction, by the internal contours of the intermediate mold component 8115. For example, a method for forming the preform 1200-1, for example as a partial preform, comprises one or more of, for example in the order a), b), c), d) or in the order a), b), d), c), or in another order:
a) positioning one or more first organosheet 150-1, for example into the compression molding system 8000, for example the second embodiment 8002 of the compression molding system, for example onto the second or bottom mold component 8120;
b) positioning one or more preform component, for example one or more anisotropic tow layup portion 1010P, for example into the compression molding system 8000, onto one or more of the first organosheet 150-1;
c) positioning one or more material pellet 1051, for example into the compression molding system 8000, for example in contact with one or more of the first organosheet 150-1, for example in contact with one or more of the anisotropic tow layup portion 1010P; and
d) positioning one or more second organosheet 150-2, for example into the compression molding system 8000, for example in contact with one or more of the anisotropic tow layup portion 1010P and the one or more material pellet 1051.

For another example, the preform 1200-1 is supplied into the compression molding system 8000 as an assembly comprising at least the first organosheet 150-1 and the one or more anisotropic tow layup portion 1010P, for example bonded to the first organosheet 150-1. For yet another example, the assembly further comprises the one or more second organosheet 150-2, for example bonded to one or more of the anisotropic tow layup portion 1010P. For still another example, the assembly further comprises the one or more material pellet 1051. For example, at least a portion of the material pellet 1051 is at least partly enclosed, for example fenced-in, for example by one or more of: a wrapping material; a grid, for example comprising one or more of an isotropic material and an anisotropic material, for example comprising elongate fibers; and a wall comprising a plurality of pellets, for example comprising a bond to one or more other pellet and another surface, for example resulting from a heat treatment, for example by one or more method of contacting the pellets with a hot surface, blowing hot air into the pellets, and projecting infrared radiation against one or more pellet.

For example, the pellet material or property comprises one or more of: a thermoplastic, for example a thermoplastic adhesive comprising one or more of a PAEK, a PEEK, a PEKK, and a PEI; a fiber, for example a chopped fiber, for example comprising one or more of a carbon fiber, a glass fiber, an aramide fiber, and a natural fiber; one or more chips, for example comprising one or more of a thermoplastic adhesive and a fiber, for example a chopped fiber. For example, a pellet has a dimension, for example in width or height, in a range from 0.5 mm to 30 mm, for example from 1 mm to 20 mm, for example from 2 mm to 10 mm. For example, the pellet originates from a recycled material, for example comprising one or more of a thermoplastic and a fiber.

For example, a plurality of pellets comprises pellets having one or more of: a plurality of dimensions, chemical composition, fiber-to-plastic ratio, for example one or more of by weight and by number of fibers, color, ratio of color pellets, and spatial color distribution. For example, the preform 1200-1 comprises one or more spatial distribution of pellet characteristic, for example one or more of: a spatial distribution of fiber-to-plastic ratio; a spatial distribution of fiber type, for example one or more of: fiber dimensions, fiber blend composition, and fiber chemical composition; and a spatial distribution of melt temperature property. For an example of a variation in spatial distribution, one or more property of pellets used at the periphery of the preform 1200-1 is different from that of pellets used within the preform. For another example of a variation in spatial distribution, one or more property of pellets used at a first end or position of the preform 1200-1 is different from that property at a second end or position of the preform. For example, the property varies spatially according to a predefined rule, for example a curve, for example a linear progression, for example one or more step functions. For example, pellets in a first region 1051R1 have a property that is different from that in a second region 1051R2.

For example, the packing arrangement of pellets in a first region 1051R1, for example a hexagonal packing arrangement, is different from the packing arrangement of pellets in a second region 1051R2, for example a square packing arrangement. For example, other packing arrangements are formed or selected as a function and diversity of one or more of pellet dimensions and proportions. For example, a packing arrangement is formed by a robotic or automated dispenser, for example one or more of prior to insertion of the preform into the compression molding system and with the preform inserted into the compression molding system.

For example, the organosheet has a fiber volume content in a range from 3% to 80%, for example from 40% to 75%, for example from 50% to 70%, for example from 55% to 65%, for example of 60%. For example, the organosheet has a polymer, for example a thermoplastic, and a polymer volume content in a range from 20% to 97%, for example from 30% to 60%, for example from 35% to 45%, for example of 40%. For example, the melt temperature of the thermoplastic comprised in the organosheet is in a range from 60° C. to 4100° C., for example from 100° C. to 2000° C., for example from 200° C. to 500° C., for example from 280° C. to 330° C., for example from 300° C. to 310° C., for example 305° C. For example, the melt temperature of the pellets is in a range from 63° C. to 4100° C., for example from 100° C. to 2000° C., for example from 200° C. to 500° C., for example from 300° C. to 370° C., for example from 330° C. to 340° C., for example of 335° C. For example, the melt temperature of the polymer comprised in the organosheet is lower than the melt temperature of the polymer comprised in the pellets, for example lower in a range from 3° C. to 200° C., for example from 10° C. to 50° C., for example from 20° C. to 40° C., for example from 25° C. to 35° C.

For example, a method in the step or process of compression molding 5400 comprises deforming 5431 one or more organosheet 150, 150-1, 150-2, 150-3, 150-4, for example comprised in a preform assembly 1200-1, 1200-2. For example, the organosheet contacts the preform assembly. For example, the organosheet is positioned at one or more surface of the preform 1200-1, 1200-2. For example, the method of compression molding 5400 comprises, for example in one or more deforming step 5431, heating one or more organosheet 150-1, 150-2 to a temperature lower than the melt temperature of the polymer comprised in the organosheet. For example, for an organosheet the melt temperature of which is in a range from 300° C. to 310° C., at least a portion of the deforming, for example an initial step in the deforming, is at a temperature in a range from 150° C. to 360° C., for example from 155° C. to 200° C., for example from 160° C. to 175° C., for example from 165° C. to 170° C., for example at 167° C. For example, one or more portion of the organosheet is deformed at a temperature comprised in a range from 150° C. below melt temperature to 50° C. above melt temperature, for example from 145° C. below melt temperature to 130° C. below melt temperature. For example, one or more portion of the organosheet is deformed at a temperature comprised in a range from, with respect to 0° C., 40% to 120% of melt temperature, for example from 50% to 100% of melt temperature, for example from 52% to 58% of melt temperature of the organosheet.

For example, the deforming 5431 one or more organosheet 150, 150-1, 150-2, 150-3, 150-4 for example comprised in a preform assembly 1200-1, 1200-2, is at a temperature that is a function of one or more material thermal property of the one or more material against which the organosheet is positioned, for example a function of the glass transition temperature of the one or more material against which the organosheet is positioned. For example, the deforming 5431 of one or more portion of the organosheet is initiated at a temperature in a range from 20° C. below the glass transition temperature to 150° C. above the glass transition temperature of the one or more material against which the organosheet is positioned, for example in a range from 10° C. below to 40° C. above, for example from 5° C. below to 5° C. above. For example, in a preform assembly 1200-1, 1200-2 comprising one or more pellet, for example a pellet comprising a PEKK polymer, for example a pellet comprising carbon fibers, for example formed as a carbon fiber reinforced compound, the deforming 5431 is initiated at a temperature comprised between 160° C. and 200° C. For example, the one or more pellet 1051, for example a plurality of pellets, is comprised in a region comprising isotropic material, for example an isotropic layup portion 1050P. For example, the deforming 5431 is initiated at a temperature, with respect to 0° C., comprised in a range from 95% to 110% of the glass transition temperature of the one or more material of the preform assembly 1200-1, 1200-2 against which the organosheet is positioned, for example of the isotropic layup portion, for example of the material comprising one or more pellet 1051.

For example, heating the organosheet, for example one or more portion of the organosheet, comprises heating by contact between one or more region of the surface of the one or more mold geometrical component 8100, 8110, 8120 used for the compression molding 5400 and one or more region at the surface of the organosheet 150-1, 150-2. For example, the surface of the one or more mold geometrical component 8100, 8110, 8120 has a temperature equal to or greater than one or more of: the glass transition temperature of material against which the organosheet is in contact, for example the isotropic layup portion 1050P, for example comprising one or more pellet; the glass transition temperature of the polymer comprised in the organosheet. For example, a temperature measurement, for example measured by one or more temperature sensor 4171 of the compression molding system 8100, has an error margin of 5% with respect to 0° C.

For example, in the method of forming a compression molding 5400, one or more organosheet 150-1, 150-2, for example positioned at one or more surface of the preform 2100-2, reaches one or more of a glass transition temperature and a melt temperature before one or more of another component of the preform, for example one or more pellet 1051, one or more isotropic layup portion, and one or more anisotropic tow layup portion 1010P reaches one or more of its respective glass transition temperature and melt temperature. For example, the method of forming a compression molding 5400 is a solution to the problem of forming a flexible sandwich delineated by a molten organosheet during the compression, for example while forming a strengthened bond to the inner sandwich material prior to the latter reaching a molten phase.

For example, at the step wherein the compression molding system 8000 starts the deforming 5431 of the organosheet, for example by applying pressure onto the organosheet, for example by motion of a compression actuator 4182, the organosheet has a temperature that is greater than the average temperature of the rest of the preform excluding one or more of the organosheet positioned at the surface of the preform, the surface of the organosheet being in contact with the compression molding system. For example, one or more of the anisotropic layup portion 1010P and the isotropic layup portion 1050P has a temperature, for example an average temperature over the portion's volume, that is lower than that of the organosheet being pressed against it.

For example, the average pressure, calculated in the direction of motion (Z) over the surface of one or more of the mold geometrical component 8100, 8110, 8120, that is exerted onto the preform 1200-1, 1200-2 is comprised in a range from 5 bar to 50 bar, for example from 10 bar to 40 bar, for example from 20 bar to 35 bar, for example from 26 bar to 32 bar.

FIG. 3I presents a cross-sectional view of a molded device 500ID3 or modeled target device second embodiment 8002, for example resulting from the preform 1200-1 of FIG. 3H having undergone, for example, a method of compression molding 5400, for example within the compression molding system 8000, 8002. For example, the pellets in one or more of the first region 1051R1 and the second region 1051R2 of the preform 1200-1 have respectively melted to form an isotropic layup portion 1050P. In a first example embodiment, the first region 1051R1 and the second region 1051R2 form an isotropic layup portion 1050P having spatially uniform material properties. In a second example embodiment, the first region 1051R1 and the second region 1051R2 respectively each form a compressed region, for example a region deformed with respect to that found in the preform 1200-1, having first material properties, for example in a first isotropic region 1051R1, and having second material properties, for example in a second isotropic region 1051R2. For example, the first region 1051R1 and the second region 1051R2 form a bonding at a border 1051B.

For example, the method of compression molding 5400 one or more organosheet 150, 150-1, 150-2 that has a temperature that is greater and, for example, one or more of a glass transition temperature and a melt temperature that is lower, than that of the material against which it is pressed provides an improved solution to one or more of the problem of: progressively heating inner material, for example the anisotropic layup portion 1010P and the isotropic layup portion 1050P; improving sliding of the organosheet against the inner material while both the organosheet and the inner material are being deformed; progressively deforming the inner material; progressively compressing the inner material; improving the uniformity and spread of inner material during compression; progressively deforming the inner material from its periphery to its innards; progressively expelling voids from the inner material; and constraining the deformation and entrainment, for example due to viscous flow of molten polymer, of the inner material, for example of the one or more tow comprised in the anisotropic layup portion 1010P.

For example, the method of compression molding 5400 one or more organosheet 150, 150-1, 150-2, 150-3, 150-4 against an inner material uses the organosheet to form one or more progressively deforming baffle, for example that constrains the flow of melting or molten inner material, whether originating from an isotropic or an anisotropic component or region, within the mold. For example, the method of progressively deforming an organosheet, for example as a deforming baffle, causes the radius of curvature of one or more of its surface portion to only reduce itself progressively under compression by one or more of the mold geometrical component 8110, 8120. The progressive reduction in radius of curvature, compared to having the mold geometrical component 8110, 8120 directly contact the inner material, forms a method to induce a more progressive and spatially distributed onset of material flow within the inner material than if a direct contact of the mold geometrical component 8110, 8120 were used.

The method of compression molding 5400 one or more organosheet 150, 150-1, 150-2, 150-3, 150-4 against an inner material is, for example compared to a method that does not comprise compressing an organosheet, an improved method to progressively compress material, eliminate voids, and reduce flow-induced deformation of one or more tow in the inner material comprised against or between the one or more organosheet. Furthermore, for example consequently, the method of compression molding 5400 one or more organosheet 150, 150-1, 150-2, 150-3, 150-4 against an inner material is a method of forming an improved bonding between different materials comprised in the preform, for example one or more of the organosheet 150, 150-1, 150-2, 150-3, 150-4, the anisotropic layup portion 1010P, and the isotropic layup portion 1050P.

FIG. 3J presents a cross-section of a further embodiment of a preform 1200-2, for example an alternative to the preform of FIG. 3H. The preform 1200-2 comprises a third organosheet 150-3, for example positioned in the inner region comprised between the first organosheet 150-1 and the second organosheet 150-2. For example, the third organosheet 150-3 is positioned between a first region 1051R1 comprising a first material, for example an isotropic material, and a second region 1051R2 comprising a second material, for example an isotropic material. For example, the third organosheet 150-3 forms a baffle between the first region 1051R1 and the second region 1051R2. For example, the third organosheet 150-3 is bonded to a material component of the preform 1200-2 one or more of prior to and during assembling or forming the preform 1200-2. For example, the third organosheet 150-3 is bonded to one or more of: an anisotropic component, for example an anisotropic tow layup portion 1010P; one or more layer of tows 1010; and one or more tow 100.

For example, one or more fourth organosheet 150-4 is position against, for example in face-to-face contact, another organosheet 150-2. For example, the fourth organosheet is positioned parallel to the other organosheet. In FIG. 3J the fourth organosheet 150-4 and the other organosheet 150-2 are represented as planar organosheets. In an alternative embodiment, for example, the fourth organosheet 150-4 and the other organosheet 150-2 comprise one or more curve, for example formed prior to assembly into the preform 1200-2. In an embodiment of the preform 1200-2 the fourth organosheet 150-4 is in sliding contact against the other organosheet 150-2.

In another embodiment of the preform 1200-2 the fourth organosheet 150-4 is bonded at one or more bonding point 150-4B with the other organosheet 150-2. For example, the one or more bonding point 150-4B is formed as one or more of: a point; a plurality of points; a dotted or dashed line; a continuous line; and a two-dimensional region at the interface between the two or more bonded organosheets 150-2, 150-4. For example, the bonding comprises one or more of: a thermoplastic adhesive bonding; an adhesive bonding; a cured resin bonding; and a mechanical fastening, for example comprising a tenon-and-mortise arrangement, for example wherein one or more organosheet comprises a tenon-and-mortise cut. For example, the bonding is positioned at one or more of: an edge of the organosheet 150-2, 150-4; and between two or more edges of the organosheet 150-2, 150-4, for example as shown in FIGS. 3J and 3K.

For example, the preform 1200-2 shown in FIG. 3J comprises one or more profiled rods 1055. For example, the first preform model 1100 comprises one or more models of profiled rods 1055. For example, a model of a profiled rod comprises a three-dimensional model of a rod comprising a plurality of continuous elongate fibers extending along the entire length of the rod. For example, the model of the profiled rod comprises a model for bonding of the fibers by a resin. For example, the one or more profiled rods are modeled as a discretized finite element object. For example, a profiled rod 1055 is formed by extrusion of a material comprising a plurality of non-aligned fibers and one or more resins. For example, a profiled rod 1055 is formed by pultrusion of a material comprising a plurality of co-aligned continuous fibers and one or more resins. For example, a resin comprised in a profiled rod is a thermoplastic resin. For example, a profiled rod comprises a coating, for example comprising a thermoplastic resin, on its exterior surface. For example, a profiled rod comprises from 5 fibers to 10 million fibers, for example from 5 to 1 million fibers, for example from 5 to 100000 fibers, for example from 5 to 50000 fibers, for example from 1100 to 40000 fibers, for example from 1100 to 5000 fibers.

For example, a profiled rod has one or more bends or folds 1055F1, 1055F2. For example, the profiled rod 1055 of FIGS. 3J and 3K has a circular cross-section. Any other cross-section geometry is possible, for example oval, rectangular, or comprising a plurality of straight and rounded contours, for example as defined by the contour of an aperture of one or more of the extrusion and pultrusion processes used for producing the raw profiled rod. FIGS. 3J and 3K show a profiled rod 1055 having one or more first folds 1055F1 in the X-Z plane. For example, the profiled rod 1055 has one or more second folds 1055F2 in the X-Y plane, as illustrated with a rounded contour corresponding to a circular cross-section of the depicted profiled rod. The orientation of the folds 1055F1, 1055F2 in the X-Z- and X-Y planes is for the purpose of graphical illustration. Other orientations or planes for the folds is possible. The angle or arc covered by the fold is, for example, less than or greater than the 180° depicted in FIG. 3J. The one or more folds 1055F1, 1055F2 of the profiled rod confer, for example, any sharp-angled or serpentine shape that a rod that is deformed with bends and folds into a plane or volume may have. For example, the profiled rod depicted in FIGS. 3J and 3K has a crenelated serpentine alternating fold arrangement having a first 180° fold in the X-Z plane, a second 180° fold in the X-Y plane, a third 180° fold (not shown) in the X-Z plane, and so on, the profiled rod being folded into a parallelepipedic or prismatic volume with a plurality of alternating folds.

FIG. 5K presents a profiled rod 1055 as initially presented in the configuration of FIG. 3J but after a step of compression molding. For example, the step of compression molding 5400 causes deforming of the profiled rod. For example, in FIG. 3J the profiled rod is arranged between the first organosheet 150-1 and the third organosheet 150-3. For example, a method for guiding the deforming of a profiled rod 1055 during a step of compression molding comprises placing the profiled rod against one or more organosheets 150-1, 150-2, 150-3, for example between the planar surfaces of a first organosheet and a second organosheet. For example, an isotropic material is placed against the profiled rod, for example one or more material pellets 1051, for providing a fluid path towards which a profiled rod expands by deforming during a step of compression molding. For example, a profiled rod 1055 is partly enclosed, for example prior to a step of compression molding, within one or more organosheets, for example an organosheet pre-folded into a U-shape. For example, forming a physical embodiment of a preform 1200-2 comprising one or more profiled rods 1055 comprises arranging one or more profiled rods 1055 into the preform 1200-2 using a robotic manipulator, for example a pick-and-place robot.

For example, forming the bonding comprises one or more of: depositing an adhesive, for example onto one or more organosheet; curing an adhesive; and heating an adhesive, for example a thermoplastic, for example a thermoplastic comprised in one or more material of the preform 1200-2, for example one or more of an organosheet 150, a pellet 1051, an isotropic material 1050, 1050P, and an anisotropic material 1010, for example a pre-impregnated material comprising fibers, for example a tow 100. For example, the curing or the heating comprises irradiating the material to be bonded, for example its adhesive, with radiation at one or more wavelength dispensed from one or more temperature adjusting position 4181P, for example: an X-ray radiation; a microwave radiation, for example in a frequency range from 1 MHz to 300 GHz; an ultraviolet radiation; and an infrared radiation, for example supplied by a laser.

In some embodiments of a preform 1200-2, one or more region, for example a region of thermoplastic, for example at the one or more bonding point 150-4B, comprises a dopant, for example comprising one or more of a plurality of ferromagnetic particles and a plurality of electrically conductive particles. For example, a method of heating one or more region of the preform 1200-2, for example of the thermoplastic it comprises, for example a region comprising the dopant, for example at the one or more bonding point 150-4B, comprises using an induction heating device, for example one or more temperature adjusting actuator 4181 at the one or more temperature adjusting position 4181P.

FIG. 6B is a graph of the relative position of a first component, for example the second organosheet 150-2, with respect to a second component, for example the fourth organosheet 150-4, as a function of time during execution of a method of compression molding 5400, whether physical or simulated using a computer-implemented method the instructions of which are, for example, stored on a computer-readable non-volatile storage medium 4120. For example, in a method of compression molding 5400, the preform 1200-2 comprises a first component that is subjected to bonding 5405 to a second component, for example at the one or more bonding point 150-4B, for example at the beginning time T0 of the method for compression molding 5400, for example via a thermoplastic bonding.

For example, the computer-implemented method 5000, for example the method of compression molding 5400, comprises one or more of forming 5100 one or more of the preforms 1100 and positioning 5410 the preforms into the compression molding system. The preforms 1100 are, for example, formed or positioned as one or more of one or more separate preforms and one or more fastened assemblies of preforms. For example, an assembly of preform comprises a plurality of preforms fastened or bonded by one or more of: a mechanical fastener, for example comprising one or more of a metal, a polymer, and a fiber; and an adhesive bonding. For example, the mechanical fasterner or the bonding is one or more of integral of and separate from one or more of the preforms.

For example, during one or more of the heating 5420 and the compressing 5430, for example at a temperature comprised between the glass transition temperature and the melt temperature of the thermoplastic forming the bonding 150-4B, the bonding softens. For example, compared to the time T0 at which the compressing starts, the relative position dP 1160 of the second part changes with respect to that of the first part, for example in a projection plane X-Y that is orthogonal to that of the direction of motion Z of the compression molding system's compression actuator 4182. The change in relative position dP 1160 is, for example, characterized as a relative motion. For example, the relative motion is along a surface that is parallel to one or more of an organosheet and a layer.

For example, the delay from time T0 to time TS at which the relative motion starts is in a range between 10 s and 600 s. For example, during the method of compression molding 5400, one or more region is heating up and, for example, is being compressed, during a first period P1 from T0 to TS wherein the second component remains bonded to the first component. For example, during the period P1 one or more of the components of the preform 1200-2 is at a temperature that is greater than the glass transition temperature of that component, for example one or more of an organosheet and a region comprising pellets, and is deforming under the pressure supplied by one or more part of the compression molding system, for example of the compression actuator 4182.

At TS the bonding is at a temperature that is greater than the glass transition temperature and the second component separates, for example slides away from, from its one or more bonding point on the first component. For example, after TS the first component changes relative position, for example at the bonding point 150-4B, for example one or more of translates, rotates, curves, and twists with respect to the second component. For example, if a second surface of the second component 150-4 that is opposite that of the bonded first surface is in contact with a material, for example an inner material 1051R2, the glass transition temperature of which is greater than that of the material forming the bonding at the first surface, the motion of the second component is, for example, prevented or further delayed by a limited friction, for example a breakout friction between the second surface and the inner material 1051R2.

For example, at time TF the one or more isotropic material is molten, for example inner material 1051R2 is molten, and the second component is freely entrained by fluid flow, for example flow of the inner material 1051R2. For example, motion of the second component continues until the time TA wherein the compression actuator 4182 has arrived at its final position.

FIG. 3K presents a cross-section of the preform 1200-2 at the end of the compression molding process, for example at time TA, with the preform formed into an alternative embodiment 500ID4 of the molded device or modeled target device that is presented in FIG. 3I. For example, the fourth organosheet 150-4, one or more extremities 150-4E1, 150-4E2 of which is immersed into a region of inner material 1051R2, is in contact, for example via a bonding 150-4B, with the second organosheet 150-2 which follows the contour of a surface of the embodiment 500ID4. For example, the bonding 150-4B is formed during hardening of isotropic material, for example thermoplastic material, between the second organosheet 150-2 and the fourth organosheet 150-4, for example during a step of cooling down, for example at or after time TA, for example at the end of the compression molding method 5400. For example, the relative position of the bonding 150-4B between the second organosheet 150-2 and the fourth organosheet 150-4 is at a first relative position at time T0 and at a different second relative position at time TA. For example, the fourth organosheet 150-4 is in contact with the second organosheet 150-2 in a region where the surface of the embodiment and, for example the second organosheet 150-2 that strengthens it, is concave. For example, a third organosheet 150-3 that is, for example, bonded at time T0 to a first component of the preform 1200-2, for example bonded to one or more layer 1010 or stack of layers 1010S, is bonded to a second component, for example solidified isotropic material of an isotropic layup portion 1050P.

For example, a method to form an embodiment of a compression molded device 500ID4 comprising a convex portion comprises depositing an organosheet assembly comprising a second organosheet 150-2 to which is bonded, in a region 150-4B, a fourth organosheet. For example, the second organosheet 150-2 is against the surface of preform to be molded into the molded device 500ID4 and the fourth organosheet is immersed against the inner region of the preform to be molded into the molded device 500ID4.

For example, the computer-implemented method 5000 for forming a molded device comprises forming a computer-based model of one or more of the preform 1200, 1200-1, for example comprising one or more of the organosheet 150, 150-1, 150-2, 150-3, 150-4, the anisotropic layup portion 1010P, and the isotropic layup portion 1050P. For example, the computer-implemented method 5000 comprises one or more domain decomposition method, for example wherein the model of one or more of the preform 1200, 1200-1 comprises one or more computational domain, for example stored as one or more of instructions and spatial coordinates on a non-volatile storage medium 4120. For example, the computational domain of the model of one or more of the preform 1200, 1200-1 comprises one or more boundary, for example at or along the spatial boundary of the one or more model of the organosheet 150, 150-1, 150-2, 150-3, the anisotropic layup portion 1010P, and the isotropic layup portion 1050P component. For example, the non-volatile storage medium 4120 comprises instructions to compute one or more of the deformation, flow, and motion of materials on a plurality of processors 4110, for example in parallel, for example wherein the parallelization inputs the components resulting from the domain decomposition method applied to the one or more of the preform 1200, 1200-1. For example, the disclosure further presents a non-transitory computer-readable storage medium 4120 having collectively stored thereon executable instructions according to the computer-implemented method 5000 that, when executed by one or more processor of a computer system, cause the computer system to at least form a fiber-reinforced composite device 500.

For example, the disclosure further presents a system 2000 for applying an elongate fiber tow 100 onto an object surface 200. For example, the system comprises one or more processor. For example, the system 2000 comprises one or more of the non-transitory computer-readable storage medium having the collectively stored thereon executable instructions according to the computer-implemented method 5000. For example, the system 2000 comprises one or more filament deposition foot 1100.

For example, the computer-implemented method 5000 for forming a molded device comprises a step of transmitting 5280 the second preform model 1200 to one or more systems 2000 for applying an elongate fiber tow 100 onto an object surface 200. For example, the non-transitory computer-readable storage medium 4120 comprises instructions for transmitting 5280 the second preform model 1200 to the system 2000. For example, the transmitting is via the data communication device 4140, for example via a wireless communication device 4141.

For example, the computer-implemented method 5000 for forming a molded device comprises a step of manufacturing 5290 the second preform model 1200 with one or more systems 2000 for applying an elongate fiber tow 100 onto an object surface 200. For example, the non-transitory computer-readable storage medium 4120 comprises instructions for manufacturing 5290 the second preform model 1200 to the system 2000. For example, the computer-implemented method 5000 for forming a molded device comprises a step of manufacturing 5290 a first set of one or more stacks 1010S or substacks 1010SS of layers of the second preform model 1200 with a first system 2000 and a second set of one or more stacks 1010S or substacks 1010SS of layers of the second preform model 1200 with a second system 2000.

The specification and drawings are, accordingly, to be regarded in an illustrative rather than a restrictive sense. It will, however, be evident that various modifications and changes are, for example, made thereunto without departing from the broader spirit and scope of the disclosure as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments become, for example, apparent upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-50. (canceled)

51. A computer-implemented method for forming a fiber-reinforced composite device comprising one or more fiber-comprising tows having a tow width, the method comprising the steps:
forming a first preform model comprising one or more anisotropic tow layup portions comprising one or more fiber-comprising tows;
receiving one or more mold geometrical components;
receiving one or more molding force vector parameters wherein one or more of the molding force vector parameters comprise a compressive force;
forming an intermediate device model by deforming the first preform model against the one or more mold geometrical components using the one or more molding force vector parameters;
forming a second preform model, wherein the step of forming the second preform model comprises adjusting the first preform model; and
transmitting the second preform model to one or more systems for applying an elongate fiber tow onto an object surface;
wherein the adjusting the first preform model comprises cutting one or more of the tows into a first tow segment and a second tow segment to form a gap separating the first tow segment from the second tow segment along a corresponding tow path within the anisotropic tow layup portion.

52. The method of claim 51, further comprising a step of manufacturing the second preform model with one or more systems for applying an elongate fiber tow onto an object surface.

53. The method of claim 51, further comprising receiving at least a portion of a layup of one or more target fiber-reinforced composite devices comprising one or more tows.

54. The method of claim 51, wherein the first preform model comprises one or more models of profiled rods.

55. The method of claim 51, further comprising forming a finite element representation of the first preform model.

56. The method of claim 51, wherein one or more of the molding force vector parameters have a norm that decreases over a portion of the time wherein the force is applied.

57. The method of claim 51, wherein one or more of the first preform model and the second preform model comprise one or more regions comprising a layup of an anisotropic material and one or more regions comprising a layup comprising an isotropic material.

58. The method of claim 57, wherein at least a portion of a material comprised in the one or more regions comprising a layup of an anisotropic material has a first porosity and the one or more regions comprising a layup of an isotropic material has a second porosity.

59. The method of claim 51, wherein one or more anisotropic tow layup portions comprise a plurality of layers stacked in a third direction and wherein one or more of the layers comprise a plurality of parallel tows.

60. The method of claim 51, wherein the adjusting the first preform model comprises longitudinally twisting one or more portions of the one or more tows from a first twist orientation to a second twist orientation.

61. The method of claim 51, wherein the adjusting the first preform model comprises forming one or more reservoirs comprising an isotropic material.

62. The method of claim 51, further comprising adjusting a length of one or more of the first tow and the second tow.

63. The method of claim 51, further comprising filling the gap with an isotropic material.

64. The method of claim 51, wherein the deforming the first preform model further comprises adjusting the temperature of the one or more mold geometrical components at one or more temperature adjusting positions each having a spatial position and a spatial extent within the volume of the one or more mold geometrical components.

65. The method of claim 51, wherein the deforming the first preform model further comprises adding a volume of a fluid into the volume enclosed within the one or more mold geometrical component.

66. The method of claim 51, wherein the forming the second preform model further comprises receiving a target fiber layer elevation map of a surface comprising one or more layers of a layup comprising one or more fiber-comprising tows.

67. The method of claim 51, further comprising:
loading one or more tow layup adjustment vectors and one or more position transformation vectors into a machine learning system, wherein the tow layup adjustment vector comprises one or more vector (V_{1 . . . N}) extending from one or more tows of the first preform model to one or more tow of the second preform model and the position transformation vector (U_{1 . . . N}) is extending from one or more tows of the first preform model to one or more tows of one or more of the intermediate device models;
loading a threshold vector set into the machine learning system, the threshold vector set comprising one or more tow positions with respect to a threshold;
forming a plurality of candidate tow layup adjustment vectors comprising a position offset with respect to one or more tows of the one or more tow layup adjustment vector; and
training the machine learning system to compare the one or more candidate tow layup adjustment vectors to the one or more position transformation vectors.

68. The method of claim 51, wherein the tow comprises a fold along a longitudinal axis of the tow.

69. A non-transitory computer-readable storage medium having collectively stored thereon executable instructions that, when executed by one or more processors of a computer system, cause the computer system to at least form a fiber-reinforced composite device according to claim 51.

70. A system for applying an elongate fiber tow onto an object surface, the system comprising:
one or more processors;
one or more filament deposition feet; and
one or more non-transitory computer-readable storage mediums having executable instruction according to claim 69 that when executed by the one or more processors operate the one or more filament deposition feet to apply the elongate fiber tow to form a fiber-reinforced composite device.
